(19) United States
(12) Patent Application Publication
(10) Pub. No.: US 2020/0027112 A1
(43) Pub. Date: Jan. 23, 2020

(54) Information Processing Method, Information Processing Device, and Computer-Readable Non-Transitory Storage Medium Storing Program

(71) Applicant: Mercari, Inc., Minato-ku (JP)

(72) Inventors: Keisuke SOGAWA, Minato-ku (JP); Megumi TADA, Minato-ku (JP); Osamu TONOMORI, Minato-ku (JP); Masahiro SANO, Minato-ku (JP); Hiroaki ARISADA, Minato-ku (JP)

(21) Appl. No.: 16/515,294

(22) Filed: Jul. 18, 2019

(30) Foreign Application Priority Data
Jul. 19, 2018 (JP) 2018-136129

(51) Int. Cl. G06Q 30/02; G06K 19/06

(52) U.S. Cl. CPC G06Q 30/0225; G06Q 20/20; G06K 19/06037; G06Q 30/0235

(57) ABSTRACT

Provided is a technique that makes it possible to collectively perform use of a coupon and settlement by a one-dimensional code or a two-dimensional code. There is provided an information processing method for receiving, from a first information processing device, a request for a one-time code for performing payment applied with a coupon, issuing, in response to the request, a first one-time code for performing the payment applied with the coupon, transmitting the issued first one-time code to the first information processing device, receiving a second one-time code and a payment amount from a third information processing device used by a user who receives payment from the user, and, when the received second one-time code is the same as the first one-time code, acquiring, from a database that manages privileges for each coupon, a privilege concerning the coupon used for the payment and settling, as a payment amount paid by the user, an amount calculated based on the acquired privilege and the payment amount.

### CROSS REFERENCE TO RELATED APPLICATION

This application is based upon and claims priority from Japanese Patent Application No. 2018-136129 filed in Japan on Jul. 19, 2018, the entire contents of which are incorporated herein by reference.

### BACKGROUND OF THE INVENTION

### Field of the Invention

The present disclosure relates to an information processing method, an information processing device, and a computer-readable non-transitory storage medium storing a program.

### Description of the Related Art

Currently, online coupon services are widely performed. A user can use a coupon owned by the user by displaying the coupon on a screen of a smartphone or the like and causing a reading machine set in a store to scan the coupon. Japanese Patent Laid-Open No. 2012-104083 (Patent Literature 1) discloses a technique capable of efficiently distributing coupons according to a store visiting cycle or the like.

As a service concerning payment, a service called QR code (registered trademark) settlement has been started. In the QR code (registered trademark) settlement, settlement is performed by reading, with a POS (Point of sale system) terminal of a store, a QR code (registered trademark) displayed on a screen of a smartphone. National Publication of International Patent Application No. 2016-534453 (Patent Literature 2) discloses a technique that makes it possible to more easily settle expenses of commodities using a barcode or a QR code (registered trademark).

When both of the use of a coupon and the QR code (registered trademark) settlement are performed, under the present situation, it is necessary to perform reduction processing by acquiring a coupon with a POS terminal first and, after the reduction processing is completed, perform settlement processing using the QR code (registered trademark). Therefore, when the QR code (registered trademark) settlement cannot be performed because of some reason, cancellation processing of a used coupon is necessary. Therefore, processing is complicated. A user needs to separately present the coupon and the QR code (registered trademark). This is time-consuming for the user. And it causes complicated processing in a server.

### SUMMARY OF THE INVENTION

An object of a first embodiment in the present disclosure is to provide a technique that makes it possible to collectively perform use of a coupon and settlement by a one-dimensional code or a two-dimensional code.

When a settlement act is facilitated by the spread of the QR code settlement, it is assumed that provision of online coupons usable during settlement is actively performed. When the provision of the online coupons is actively performed, it is assumed that a user owns a large number of coupons in a terminal and has trouble in finding usable coupons.

An object of a second embodiment in the present disclosure is to provide a technique capable of notifying a user of coupons usable in neighboring stores among the coupons owned by the user.

When a settlement act is facilitated by the spread of the QR code settlement, it is assumed that provision of online coupons usable during settlement is actively performed. When the provision of the online coupons is actively performed, it is assumed that the user cannot use the owned coupons before expiration periods and the coupons are wasted.

An object of a third embodiment in the present disclosure is to provide a technique capable of transferring coupons close to expiration periods among the coupons owned by the user.

When a settlement act is facilitated by the spread of the QR code settlement, it is assumed that provision of online coupons usable during settlement is actively performed. When the provision of the online coupons is actively performed, it is assumed that the user owns a large number of coupons in a terminal and has trouble in finding usable coupons. It is assumed that the user cannot use the owned coupons before expiration periods and the coupons are wasted.

An object of a fourth embodiment in the present disclosure is to provide a technique capable of notifying a user of coupons close to expiration periods and usable in neighboring stores among coupons owned by the user.

An information processing method according to the first embodiment of the present disclosure is an information processing method executed by a second information processing device that communicates with a first information processing device used by a user, the information processing method including: a first receiving step for receiving, from the first information processing device, a request for a one-time code for performing payment applied with a coupon; an issuing step for issuing, in response to the request, a first one-time code for performing the payment applied with the coupon; a transmitting step for transmitting the issued first one-time code to the first information processing device; a second receiving step for receiving a second one-time code and a payment amount from a third information processing device used by a user who receives payment from the user; and a settlement processing step for, when the received second one-time code is same as the first one-time code, acquiring, from a database that manages privileges for each coupon, a privilege concerning the coupon used for the payment and settling, as a payment amount paid by the user, an amount calculated based on the acquired privilege and the payment amount.

An information processing method according to the second embodiment of the present disclosure is an information processing method executed by a second information processing device that communicates with a first information processing device used by a user, the information processing method including: a first issuing step for issuing a first one-time code for performing payment without applying a coupon; a specifying step for specifying a position of the first information processing device; an extracting step for extracting, among one or more coupons owned by the user, coupons usable within a predetermined range from the specified position of the first information processing device; a transmitting step for transmitting the extracted usable coupons to the first information processing device; and a second issuing step for issuing a second one-time code for performing payment by applying a coupon selected by the user among the usable coupons, the second one-time code being different from the first one-time code.

An information processing method according to the third embodiment of the present disclosure is a computing device implemented method of settlement processing executed by one or more processors of a second computing device that communicates with a first computing device used by a first user, comprising: electronically specifying one or more coupons associated with the first user; electronically specifying one or more second users who has a predetermined relationship with the first user; electronically transmitting information indicating the coupon to the first computing device; electronically transmitting information indicating the specified one or more second users who has the predetermined relationship with the first user, to the first computing device; electronically receiving information indicating at least one of the second user as an assignee of the coupon from the first computing device; and electronically adding the second user as an assignee of the coupon to users associated with the coupon.

An information processing method according to the fourth embodiment of the present disclosure is an information processing method executed by a second information processing device that communicates with a first information processing device used by a user, the information processing method including: a managing step for receiving, from the first information processing device, position information indicating a position of the first information processing device to manage the position of the first information processing device; an extracting step for extracting a coupon, an expiration period of which is set within a predetermined period, among one or more coupons owned by the user, the coupon being usable within a predetermined range from the position of the first information processing device; and a transmitting step for transmitting the extracted usable coupon to the first information processing device.

### BRIEF DESCRIPTION OF THE DRAWINGS

FIG. 1 is a diagram showing the configuration of a communication system according to an aspect of an embodiment;

FIG. 2 is a diagram showing an example of a hardware configuration of an information processing device and a POS terminal according to the present disclosure;

FIG. 3 is a diagram showing an example of a block diagram showing a configuration of a server according to a first embodiment;

FIGS. 4A to 4C are diagrams showing examples of a user management DB, a coupon management DB, and a settlement management DB according to the first embodiment;

FIG. 5 is a diagram showing an example of a block diagram showing a configuration of a terminal according to the first embodiment;

FIG. 6 is a diagram showing an example of a sequence of a processing procedure performed by a communication system according to the first embodiment;

FIGS. 7A to 7D are diagrams showing examples of settlement screens displayed on the terminal according to the first embodiment;

FIG. 8 is a diagram showing an example of a sequence of a processing procedure performed by a communication system according to a first example of the first embodiment;

FIG. 9 is a diagram showing an example of a block diagram showing a configuration of a server according to a second embodiment;

FIG. 10 is a diagram showing an example of a store management DB according to the second embodiment;

FIG. 11 is a diagram showing an example of a block diagram showing a configuration of a terminal according to the second embodiment;

FIG. 12 is a diagram showing an example of a sequence of a processing procedure performed by a communication system according to the second embodiment;

FIG. 13 is a diagram showing an example of a sequence of a processing procedure performed by the communication system according to the second embodiment;

FIG. 14 is a diagram showing an example of a block diagram showing a configuration of a server according to a third embodiment;

FIGS. 15A and 15B are diagrams showing examples of a friend management DB and a assign history DB according to the third embodiment;

FIG. 16 is a diagram showing an example of a block diagram showing a configuration of a terminal according to the third embodiment;

FIG. 17 is a diagram showing an example of a sequence of a processing procedure performed by a communication system according to the third embodiment;

FIG. 18 is a diagram showing an example of a sequence of a processing procedure performed by the communication system according to the third embodiment;

FIG. 19 is a diagram showing an example of a block diagram showing a configuration of a server according to a fourth embodiment;

FIG. 20 is a diagram showing an example of a user management DB according to the fourth embodiment; and

FIG. 21 is a diagram showing an example of a sequence of a processing procedure performed by a communication system according to the fourth embodiment.

### DETAILED DESCRIPTION OF THE PREFERRED EMBODIMENTS

### <Compliance>

Disclosure described in this specification is, when being implemented, implemented while observing laws of countries where the present disclosure is implemented. The disclosure described in this specification is implemented with all changes, substitutions, modifications, alternations, and corrections that are necessary for observing the laws of the countries and those skilled in the art could make.

A form for implementing a communication system 1 according to the present disclosure is explained with reference to the drawings.

### <System Configuration>

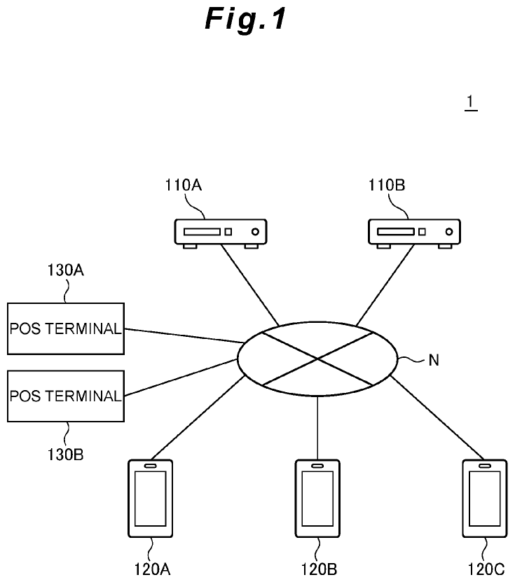

FIG. 1 shows the configuration of the communication system 1 according to an embodiment of the present disclosure. As disclosed in FIG. 1, in the communication system 1, a server 110A, a server 110B, a terminal 120A, a terminal 120B, a terminal 120C, a POS terminal 130A, and a POS terminal 130B are connected via a network N.

In this disclosure, when it is unnecessary to distinguish the server 110A and the server 110B from each other, the server 110A and the server 110B may be respectively represented as server 110.

In the present disclosure, when it is unnecessary to distinguish the terminal 120A, the terminal 120B, and the terminal 120C from one another, the terminal 120A, the terminal 120B, and the terminal 120C may be respectively represented as terminal 120.

In the present disclosure, when it is unnecessary to distinguish the POS terminal 130A and the POS terminal 130B from each other, the POS terminal 130A and the POS terminal 130B may be respectively represented as POS terminals 130.

In the present disclosure, when it is unnecessary to distinguish the servers 110 and the terminals 120 from each other, the servers 110 and the terminals 120 may be respectively represented as information processing devices 200. Note that the numbers of the information processing devices 200 connected to the network N is not limited.

The servers 110 provide a predetermined service to the terminals 120 used by users via the network N. The predetermined service includes, not as limitations but as examples, a settlement service, an electronic commerce service, an SNS (Social Networking Service) represented by an instant messenger, a content providing service for music, moving images, books, and the like, and a coupon providing service. When the users use the predetermined service via the terminals 120, the servers 110 can provide the predetermined service to one or more terminals 120.

According to necessity, a terminal used by a user X is represented as a terminal 120X and user information in the predetermined service associated with the user X or the terminal 120X is represented as user information X. Note that the user information is information concerning a user associated with an account used by the user in the predetermined service. The user information includes, not as limitations but as examples, information associated with the user such as a name of the user, an icon image of the user, age of the user, sex of the user, an address of the user, preference of the user, and an identifier of the user input by the user or given by the predetermined service. The user information may be one of these kinds of information or may be a combination of these kinds of information.

The network N plays a role of connecting two or more information processing devices 200. The network N means a communication network that provides a connection path to enable the terminals 120 to transmit and receive data after being connected to the servers 110. The servers 110 and the POS terminals 130 are connected by the network N.

One or a plurality of portions of the network N may be a wired network or a wireless network. The network N may include, not as limitations but as examples, an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of a public switched telephone network (PSTN), a cellular phone network, ISDNs (Integrated Service Digital Networks), wireless LANs, an LTE (Long Term Evolution), a CDMA (Code Division Multiple Access), a Bluetooth (registered trademark), and satellite communication or a combination of two or more of these networks. The network N may include one or a plurality of networks. A gateway device provided by a settlement provider may be included between the servers 110 and the POS terminals 130.

The information processing device 200 may be any information processing device if the information processing device can realize processes, functions and/or methods described in this disclosure.

The information processing device 200 includes, not as limitations but as examples, a smartphone, a cellular phone (a feature phone), a computer (including, not as limitations but as examples, a desktop computer, a laptop computer, and a tablet computer), a server device, a media computer platform (including, not as limitations but as examples, a cable, a satellite set-top box, and a digital video recorder), a hand-held computer device (including, not as limitations but as examples, a PDA (Personal Digital Assistant) and an electronic mail client), a wearable terminal (including, not as limitations but as examples, an eyeglass-type device and a watch-type device), other kinds of computers, or a communication platform.

The POS terminals 130 are terminals used by users (store clerks, etc.) who receive payment from users (customers) in a store. The POS terminals 130 includes two-dimensional code readers and transmits a scan two-dimensional code to the servers 110.

### <Hardware Configuration>

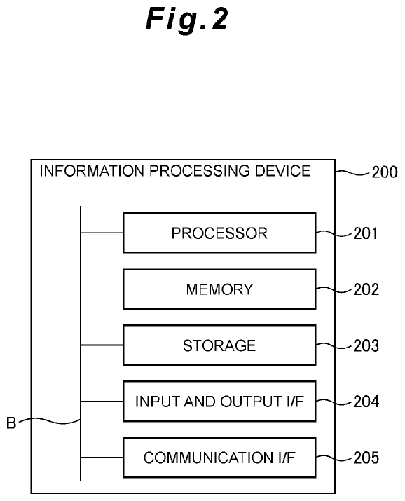

A Hardware configuration of the information processing device 200 and the POS terminal 130 included in the communication system 1 is explained with reference to FIG. 2.

The information processing device 200 and the POS terminal 130 include a processor 201, a memory 202, a storage 203, an input and output interface (input and output I/F) 204, and a communication interface (communication I/F) 205. The components of Hardware of the information processing device 200 and the POS terminal 130 is, not as a limitation but as an example, connected to one another via a bus B.

The information processing device 200 and the POS terminal 130 realize processes, functions and/or methods described in the present disclosure according to cooperation of the processor 201, the memory 202, the storage 203, the input and output I/F 204, and the communication I/F 205.

The processor 201 executes processes, functions and/or methods realized by codes or commands included in programs stored in the storage 203. The processor 201 includes, not as limitations but as examples, a central processing unit (CPU), an MPU (Micro Processing Unit), a GPU (Graphics Processing Unit), a microprocessor, a processor core, a multiprocessor, an ASIC (Application-Specific Integrated Circuit), and an FPGA (Field Programmable Gate Array). The processor 201 may realize respective kinds of processing disclosed in embodiments with a logic circuit (hardware) and a dedicated circuit formed in an integrated circuit (IC) chip, an LSI (Large Scale Integration), or the like. These circuits may be realized by one or a plurality of integrated circuits. A plurality of kinds of processing explained in the embodiments may be realized by one integrated circuit. The LSI is sometimes called VLSI, super LSI, ultra LSI, and the like according to differences in an integration degree.

The memory 202 temporarily stores a program loaded from the storage 203 and provides a work area to the processor 201. The memory 202 also temporarily stores various data generated while the processor 201 is executing the program. The memory 202 includes, not as limitations but as examples, a RAM (Random Access Memory) and a ROM (Read Only Memory).

The storage 203 stores programs. The storage 203 includes, not as limitations but as examples, a HDD (Hard Disk Drive), an SSD (Solid State Drive), and a flash memory.

The communication I/F 205 performs transmission and reception of various data via the network N. Communication by the communication I/F 205 may be executed either by wire or by radio. Any communication protocol may be used if the communication can be executed. The communication I/F 205 executes communication with other information processing devices via the network N. The communication I/F 205 transmits various data to the other information processing devices according to an instruction from the processor 201. The communication I/F 205 receives various data transmitted from the other information processing devices and transmits the various data to the processor 201.

The input and output I/F 204 includes an input device for inputting various kinds of operation for the information processing device 200 and the POS terminal 130 and an output device for outputting a processing result of processing in the information processing device 200 and the POS terminal 130. In the input and output I/F 204, the input device and the output device may be integrated. The input and output I/F 204 may be separated into the input device and the output device.

The input device is realized by any one of all kinds of devices that can receive an input from the user and transmit information related to the input to the processor 201 or is realized by a combination of the devices. The input device includes, not as limitations but as examples, a touch panel, a touch display, a hardware key such as a keyboard, a pointing device such as a mouse, a camera (an operation input via an image), and a microphone (an operation input by voice). In the case of the POS terminal 130, the input device includes a two-dimensional code reader.

The output device is realized by any one of all kinds of devices that can output a processing result of processing in the processor 201 or a combination of the devices. When the processing result is output as a video, a moving image and/or an image, the output device is realized by any one of all kinds of devices that can display, according to display data written in a frame buffer, the display data or is realized by a combination of the devices. The output device includes, not as limitations but as examples, a touch panel, a touch display, a monitor (including, not as limitations but as examples, a liquid crystal display and an OELD (Organic Electroluminescence Display)), a head mounted display (HMD), projection mapping, a hologram, a device capable of displaying an image, text information, and the like in the air and the like (which may be a vacuum), a speaker (a sound output), and a printer. Note that these output devices may be capable of three-dimensionally displaying display data.

Programs in the embodiments of the present disclosure may be provided in a state in which the programs are stored in a computer-readable storage medium. The storage medium is capable of storing the programs in a “non-transitory tangible medium”. The programs include, not as limitations but as examples, a software program and a computer program.

In an appropriate case, the storage medium can include an integrated circuit based on one or a plurality of semiconductors or other integrated circuits (ICs) (including, not as limitations but as examples, a field programmable gate array (FPGA) and an application specific integrated circuit (ASIC)), a hard disk drive (HDD), a hybrid hard drive (HHD), an optical disk, an optical disk drive (ODD), a magneto-optical disk, a magneto-optical drive, a floppy diskette, a floppy disk drive (FDD), a magnetic tape, a solid-state drive (SSD), a RAM drive, a secure digital card or drive, or any other appropriate storage medium or an appropriate combination of two or more of these media. In an appropriate case, the storage media may be a volatile storage medium, a nonvolatile storage medium, or a combination of the volatile and nonvolatile storage media.

The program of the present disclosure may be provided to the information processing device 200 via any transmission medium (a communication network, a broadcasting wave, etc.) capable of transmitting the program.

The embodiments of the present disclosure may also be realized in a form of a data signal obtained by embodying the program with electronic transmission and embedded in a carrier wave.

Note that the program of the present disclosure is implemented using, not as limitations but as examples, a script language such as Action Script or Java Script (registered trademark), an object-oriented programming language such as Objective-C or Java (registered trademark), a markup language such as HTML5, and the like.

At least a part of processing in the information processing device 200 may be realized by cloud computing configured by one or more computers.

At least a part of the processing in the information processing device 200 may be performed by the other information processing devices. In this case, at least a part of processing of the units realized by the processor 201 may be performed by the other information processing devices.

### <Others>

Unless explicitly referred to, the configuration of determination in the embodiments of the present disclosure is not essential. Predetermined processing may be performed when a determination condition is satisfied or the predetermined processing may be performed when the determination condition is not satisfied.

In the present disclosure, unless clearly described or unless indicated by a context, “or” is not an exclusive means and is an inclusive means. Therefore, in the present disclosure, unless clearly described or unless indicated by a context, “A or B” means “A, B, or both of A and B”. Further, unless clearly described or unless indicated by a context, “and” has meanings of both of joint and several. Therefore, in this specification, unless clearly described or unless indicated by a context, “A and B” means “A and B jointly or severally”. Further, unless clearly described or unless indicated by a context, “a”, “an”, or “the” means “one or a plurality of”. Therefore, in this specification, unless clearly described otherwise or unless indicated by a context, “an A” or “the A” means “one or a plurality of As”.

The present disclosure includes all changes, substitutions, modifications, alterations, and corrections that those skilled in the art could make for the embodiments and/or examples of the present disclosure. Similarly, in an appropriate case, the appended claims include all changes substitutions, modifications, alterations, and corrections that those skilled in the art could make for the embodiments and/or the examples of the present disclosure. Further, the present disclosure includes any combinations of one or a plurality of characteristics of the embodiments and/or the examples in the present disclosure and one or a plurality of characteristics of other embodiments and/or examples in the present disclosure that those skilled in the art could make.

In addition, reference in the appended claims to a device or a system or components of the device or the system that are adapted, are disposed, have abilities, are configured, are usable, are operable, or can operate to implement specific processes, functions and/or methods includes the device, the system, and the components irrespective of whether the device, the system, the components, or the specific processes, functions and/or methods thereof are activated, turned on, or unlocked as long as the device, the system, or the components are adapted, are disposed, have abilities, are configured, are enabled to be used, are enabled to be operated, or can operate in that way.

### First Embodiment

A first embodiment is an embodiment in which, during payment in a store or the like, when both of application of a coupon and settlement by a one-dimensional code or a two-dimensional code are performed, subtraction processing and settlement processing by the application of the coupon are collectively performed. Note that the one-dimensional code may be, not as a limitation but as an example, a barcode. The two-dimensional code may be, not as limitations but as examples, a QR code (registered trademark), AztecCode, PDF417 and the like. In the following explanation, for convenience of explanation, the explanation is based on the premise that the settlement by the two-dimensional code is performed. However, the first embodiment (and second to fourth embodiments) can also be applied to the settlement by the one-dimensional code.

A predetermined privilege is given to a coupon. The predetermined privilege is a privilege of reduction from a payment amount during settlement. The privilege may be, not as a limitation but as an example, a discount amount or a discount rate (e.g., 10% OFF). In the following explanation, for convenience of explanation, the explanation is based on the premise that the privilege given to the coupon is the discount amount. However, the first embodiment (and the second to fourth embodiments) can be applied to any privilege if the privilege is reduction from a payment amount during settlement.

In the first embodiment, the settlement processing by the two-dimensional code performed by the server 110 and the terminal 120 is referred to as “two-dimensional code settlement”. Data for generating the two-dimensional code used for the settlement processing is referred to as the “one-time code”.

In the first embodiment, a two-dimensional code capable of applying a coupon and performing settlement is issued. Consequently, during payment by the two-dimensional code, it is possible to collectively perform the application of the coupon and the settlement processing rather than separately perform the application of the coupon and the settlement processing.

By collectively performing the application of the coupon and the settlement processing, processing speed in executing discount processing and the settlement processing by the application of the coupon is improved. Further, troublesome screen operation for displaying the coupon on a screen and then displaying the two-dimensional code on the screen is unnecessary. Therefore, an effect is obtained that payment processing is smoothly performed.

In the past, a POS or a coupon issuing system set in a store needs to perform reduction processing by coupon use and then perform the two-dimensional code settlement. However, according to the first embodiment, the server 110 can collectively perform the reduction processing of the coupon and the settlement processing. Therefore, it is possible to reduce the number of times of communication performed by the POS terminal 130.

When the POS or the coupon issuing system performs the reduction processing and then performs the two-dimensional code settlement as in the past, if the POS or the coupon issuing system fails in the two-dimensional code settlement, the POS or the coupon issuing system needs to reset “roll back” the reduction processing by the coupon use. Therefore, a processing procedure is complicated. However, according to the first embodiment, the server 110 collectively performs the reduction processing of the coupon and the settlement processing. Therefore, even when the same situation occurs, it is easily possible to perform the roll back.

It is explicitly displayed on a settlement screen displayed on the terminal 120 whether payment is performed without applying the coupon or payment is performed with applying the coupon. Consequently, when the coupon is applied after the two-dimensional code is once displayed on the settlement screen, the user is capable of visually recognizing that the coupon is applied or not.

### <Configuration in the First Embodiment>

### (1) Configuration of the Server

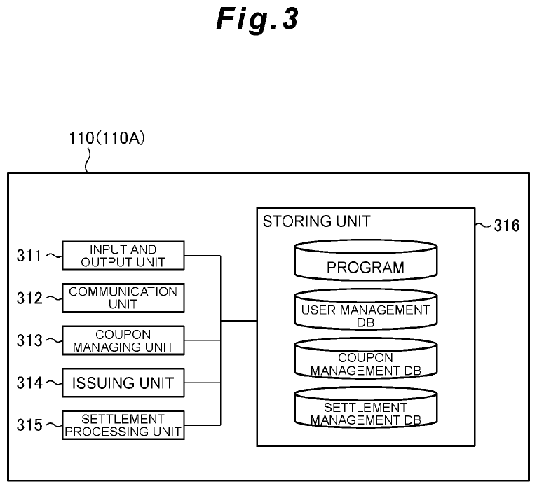

A configuration of the server 110 is explained with reference to FIG. 3. Units disclosed in FIG. 3 are realized by cooperation of the processor 201, the memory 202, the storage 203, the input and output I/F 204, and the communication I/F 205 included in the information processing device 200.

The server 110 includes an input and output unit 311, a communication unit 312, a coupon managing unit 313, an issuing unit 314, a settlement processing unit 315, and a storing unit 316. The input and output unit 311, the communication unit 312, the coupon managing unit 313, the issuing unit 314, and the settlement processing unit 315 are realized by the processor 201 reading out and executing programs stored in the storing unit 316. The storing unit 316 is realized using the memory 202 and/or the storage 203.

The storing unit 316 stores programs executed by the server 110 according to the first embodiment, a user management Database “DB” that manages users' information who use the two-dimensional code settlement, a coupon management DB that manages coupons owned by the users, and a settlement management DB that manages histories of settlement processing performed by the users.

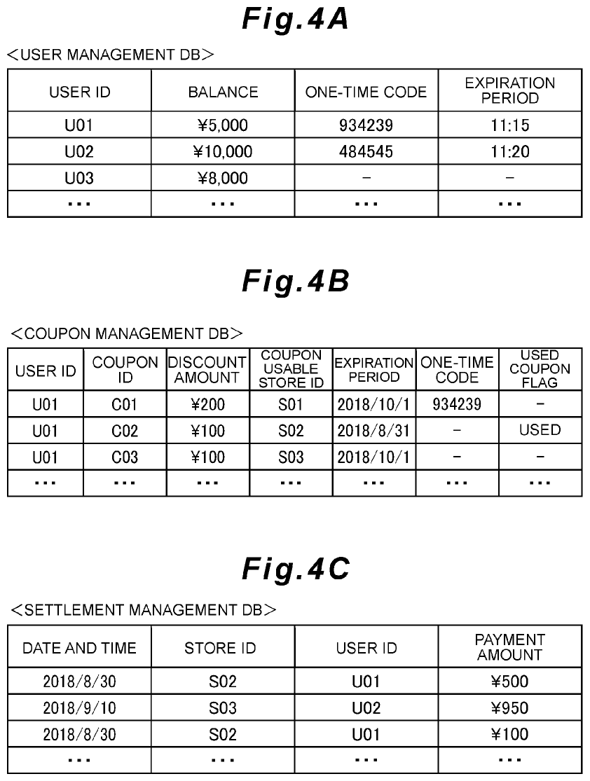

An example of the user management DB is shown in FIG. 4A. An Identifier “ID” for the server 110 to uniquely identifying a user is stored in “user ID”. A balance of money owned by the user is stored in “balance”. A one-time code issued by the server 110 in order to perform the two-dimensional code settlement or a one-time code issued by the server 110 in order to perform both of application of a coupon and the two-dimensional code settlement is stored in “one-time code”. When payment is completed or an expiration period expires, the one-time code is invalidated and deleted. A period in which the one-time code is valid is stored in “expiration period”.

An example of the coupon management DB is shown in FIG. 4B. An ID for the server 110 to specify a user is stored in the “user ID”. An ID for the server 110 to specify a coupon is stored in “coupon ID”. An amount deducted from a payment amount by applying the coupon is stored in “discount amount”. A store ID indicating a store where the coupon is usable is stored in “coupon usable store ID”. Note that the store ID is an ID for specifying a store managed by the server 110. A period in which the coupon is usable is stored in the “expiration period”. A one-time code issued by the server 110 in order to perform both of the application of the coupon and the two-dimensional code settlement is stored in the “one-time code”. A flag indicating that the coupon is already used is stored in “used coupon flag”. When the flag is set, it indicates that the coupon is already used. When the flag is not set, it indicates that the coupon is not used yet.

An example of the settlement management DB is shown in FIG. 4C. A date and time when the two-dimensional code settlement is completed is stored in “date and time”. A store ID of a store where the two-dimensional code settlement is performed is stored in “store ID”. An ID for the server 110 to specify a user is stored in the “user ID”. A payment amount at the time when the two-dimensional code settlement is performed is stored in “payment amount”. Note that, when discount by coupon application is performed, an amount after the discount is stored in the payment amount.

The input and output 311 receives input of various data via the input and output I/F 204 and processing for outputting various data via the input and output I/F 204.

The communication 312 receives various data from the terminal 120 and the POS terminal 130 via the communication I/F 205 and processing for transmitting various data to the terminal 120 and the POS terminal 130 using the communication I/F 205.

The communication unit 312 functions as a receiving unit (a first receiving unit) that receives a request for a one-time code from the terminal 120. The communication unit 312 transmits a one-time code issued for a specific user by the issuing unit 314 to the terminal 120 of the specific user. The communication unit 312 receives, from the POS terminal 130, a one-time code and a payment amount read by the POS terminal 130. (a second receiving unit)

The coupon managing unit 313 manages coupons owned by the user. For example, the coupon managing unit 313 performs processing such as issuance of a new coupon and discarding of a used coupon using the coupon management DB.

The issuing unit 314 issues a one-time code (a first one-time code) to the user in response to the request for a one-time code received from the terminal 120 by the communication unit 312. More specifically, the issuing unit 314 performs issuance of a one-time code for performing payment without applying a coupon (i.e., normal payment) or a one-time code for performing payment applied with a coupon.

When the issuing unit 314 issues the one-time code for performing payment without applying a coupon, the issuing unit 314 stores the issued one-time code in a “one-time code” field in a record of the user, for whom the one-time code is issued, in the user management DB.

On the other hand, when the issuing unit 314 issues the one-time code for performing payment by applying a coupon, the issuing unit 314 stores the issued one-time code in both of a “one-time” field of the user, for whom the one-time code is issued, in the user management DB and a “one-time” field of a coupon scheduled to be applied in the coupon management DB. In other words, the issuing unit 314 stores the issued one-time code in the coupon management DB (database) in association with a coupon ID (coupon information) indicating a coupon applied during payment and the user who makes payment.

Note that, when the one-time code for performing payment without applying a coupon is already issued before the one-time code for performing payment applied with a coupon issues, the issuing unit 314 may discard the issued one-time code and issue a new one-time code different from the discarded one-time code. Alternatively, the issuing unit 314 may repeatedly use the issued one-time code as it is without discarding the issued one-time code.

When the communication unit 312 receives a changing request for a one-time code from the terminal 120, the issuing unit 314 may issue, in response to the changing request for the one-time code, a one-time code different from the issued one-time code again. When the issued one-time code is the one-time code for performing payment without applying a coupon, the issuing unit 314 reissues the one-time code for performing payment without applying a coupon. On the other hand, when the issued one-time code is the one-time code for performing payment applied with a coupon, the issuing unit 314 reissues the one-time code for performing payment applied with a coupon.

The issuing unit 314 may issue a one-time code including a coupon ID of a coupon applied during payment. In other words, the coupon ID may be embedded in the one-time code.

The settlement processing unit 315 executes various kinds of processing for the two-dimensional code settlement. Specifically, when the one-time code (the second one-time code) received from the POS terminal 130 by the communication unit 312 is the same as the one-time code (the first one-time code) issued by the issuing unit 314, the settlement processing unit 315 specifies a coupon applied during payment by inquiring the coupon management DB (database) about a coupon ID (coupon information) associated with the one-time code received from the POS terminal 130. The settlement processing unit 315 acquires a discount amount concerning the coupon applied during payment from the coupon management DB (database) and settles, as a payment amount paid by the user, an amount obtained by subtracting the acquired discount amount from a payment amount.

When the one-time code (the second one-time code) received from the POS terminal 130 by the communication unit 312 is the same as the one-time code (the first one-time code) issued by the issuing unit 314, the settlement processing unit 315 may specify the coupon applied during payment by acquiring a coupon ID (coupon information) out of the one-time code received from the POS terminal 130.

### (2) Configuration of the Terminal

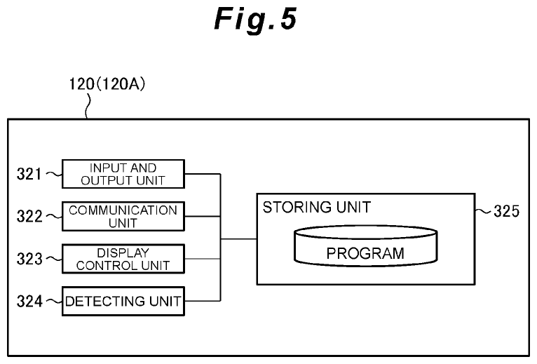

A configuration of the terminal 120 is explained with reference to FIG. 5. Each unit disclosed in FIG. 5 are realized by cooperation of the processor 201, the memory 202, the storage 203, the input and output I/F 204, and the communication I/F 205 included in the information processing device 200.

The terminal 120 includes an input and output unit 321, a communication unit 322, a display control unit 323, a detecting unit 324, and a storing unit 325. The input and output unit 321, the communication unit 322, the display control unit 323, and the detecting unit 324 are realized by the processor 201 reading out and executing programs stored in the storing unit 325. The storing unit 325 is realized using the memory 202 and/or the storage 203.

The input and output unit 321 inputs various data via the input and output I/F 204 and outputs various data via the input and output I/F 204.

The communication unit 322 receives various data from the server 110 via the communication I/F 205 and processing for transmitting various data to the server 110 using the communication I/F 205. More specifically, the communication unit 322 transmits, in response to an instruction of the user, an issuance request for a one-time code to the server 110. The communication unit 322 receives an issued one-time code from the server 110.

When receiving an instruction from the detecting unit 324, the communication unit 322 may transmit a changing request for a one-time code to the server 110.

The display control unit 323 generates a two-dimensional code from the one-time code received by the communication unit 322 and displays the two-dimensional code on a two-dimensional code display screen (hereinafter referred to as “settlement screen”). Note that, during the display of the two-dimensional code on the settlement screen, when the communication unit 322 receives a new one-time code (i.e., the one-time code is changed), the display control unit 323 replaces the two-dimensional code already displayed on the settlement screen with a two-dimensional code generated from the new one-time code and displays the two-dimensional code. In this case, the display control unit 323 may display, on the settlement screen, information indicating that the two-dimensional code is replaced in order to notify the user that the two-dimensional code is replaced. When the new one-time code is the one-time code applied with a coupon, the display control unit 323 may display, on the settlement screen, information indicating that the two-dimensional code is the two-dimensional code for performing payment applied with a coupon.

The detecting unit 324 detects a trigger with which the two-dimensional code displayed on the settlement screen should be changed. The trigger with which the two-dimensional code should be changed is desirably a case in which an act likely to cause leakage of the two-dimensional code displayed on the settlement screen to the outside is successfully detected.

The storing unit 325 stores programs executed by the server 110 according to the first embodiment.

### <Operation Processing in the First Embodiment>

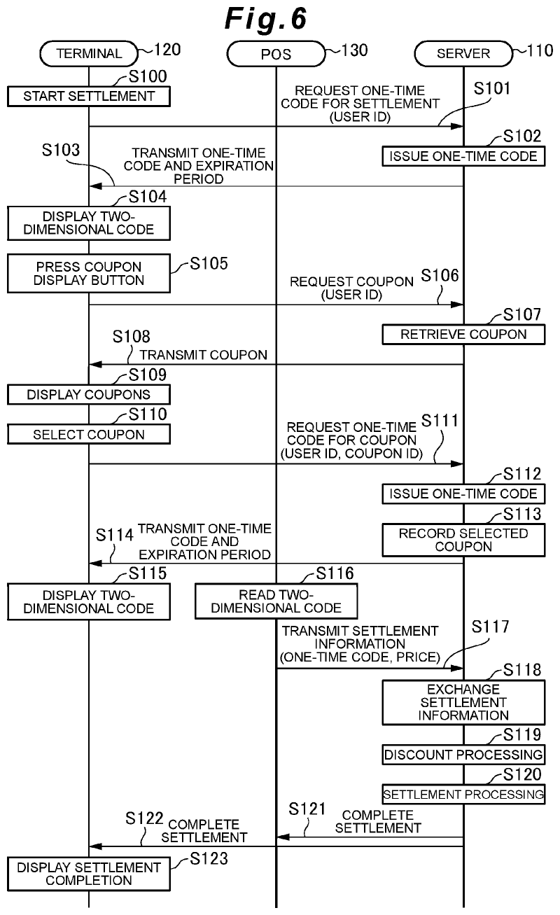

Processing of the communication system 1 according to the first embodiment is explained with reference to FIG. 6. FIG. 6 shows an example of a sequence of a processing procedure performed by the communication system 1 according to the first embodiment. The example shown in FIG. 6 is a sequence that assumes that the user once displays a two-dimensional code for performing payment without applying a coupon (i.e., a two-dimensional code used for normal payment) but, thereafter, switches the payment to payment applied with a coupon. If the user operates the terminal 120 to perform payment by applying a coupon from the beginning, processing procedures in steps S100 to S104 are omitted.

In step S100, the input and output unit 321 of the terminal 120 receives a start of the two-dimensional code settlement from the user. For example, the input and output unit 321 receives pressing of a button for displaying the settlement screen in an application in which the user performs the two-dimensional code settlement.

In step S101, the communication unit 322 of the terminal 120 transmits a message for requesting the server 110 to issue a one-time code for performing payment without applying a coupon. The message includes a user ID of the user.

In step S102, the issuing unit 314 of the server 110 issues a one-time code and stores the issued one-time code in the “one-time code” of the user, who makes payment, in the user management DB.

In step S103, the communication unit 312 of the server 110 transmits the issued one-time code and an expiration period of the one-time code to the terminal 120.

In step S104, the display control unit 323 of the terminal 120 generates a two-dimensional code from the received one-time code and displays the two-dimensional code on the settlement screen. An expiration period of the one-time code is displayed on the settlement screen. The expiration period of the one-time code may be displayed as it is or a remaining time until the expiration period expires may be displayed.

Note that, in the processing procedure of step S102, the issuing unit 314 may issue a two-dimensional code (a two-dimensional code image) together with the one-time code. The issued two-dimensional code is transmitted from the server 110 to the terminal 120 in the processing procedure of step S103. In the processing procedure of step S104, the display control unit 323 of the terminal 120 may display the received two-dimensional code on the settlement screen as it is. In other words, the server 110 issuing a one-time code and transmitting the one-time code to the terminal 120 may include the server 110 issuing a two-dimensional code and transmitting the two-dimensional code to the terminal 120. Similarly, the terminal 120 generating a two-dimensional code from the received one-time code and displaying the two-dimensional code on the settlement screen may include the terminal 120 displaying the received two-dimensional code on the settlement screen.

In step S105, the input and output unit 321 of the terminal 120 receives, from the user, an instruction for display of a screen on which a list of coupons owned by the user is displayed (hereinafter referred to as “coupon list screen”).

In step S106, the communication unit 322 of the terminal 120 transmits a message for requesting information for displaying the coupon list screen. The message includes the user ID of the user.

In step S107, the coupon managing unit 313 of the server 110 searches through the coupon management DB using the received user ID as a key to extract a coupon owned by the user.

In step S108, the communication unit 312 of the server 110 transmits a coupon ID, a discount amount, an expiration period, and a coupon usable store ID of the extracted coupon to the terminal 120.

In step S109, the display control unit 323 of the terminal 120 displays the coupons owned by the user on the coupon list screen. Coupon usable stores, discount amounts, expiration periods, and the like are displayed for each of the coupons on the coupon list screen.

In step S110, the input and output unit 321 of the terminal 120 receives, from the user, selection of a coupon applied during payment.

In step S111, the communication unit 322 of the terminal 120 transmits a message for requesting the server 110 to issue a one-time code for performing payment by applying a coupon. The message includes the user ID of the user who makes payment and a coupon ID of the coupon selected by the user in the processing procedure of step S110.

In step S112, the issuing unit 314 of the server 110 issues a new one-time code. The issuing unit 314 stores the issued one-time code in the “one-time code” of the user, who makes payment, in the user management DB and stores a decided predetermined period in the “expiration period” in the user management DB.

In step S113, the issuing unit 314 of the server 110 stores the issued one-time code in the “one-time code” of the coupon notified in step S112 (i.e., selected by the user) in the coupon management DB.

In step S114, the communication unit 312 of the server 110 transmits a message including the issued one-time code and the expiration period of the one-time code to the terminal 120.

In step S115, the display control unit 323 of the terminal 120 generates a two-dimensional code from the received one-time code and displays the two-dimensional code on the settlement screen. At this time, the display control unit 323 may display, on the settlement screen, information indicating that the two-dimensional code is a two-dimensional code for performing payment applied with a coupon. Note that the message received in the processing procedure of step S114 may explicitly include information indicating that the one-time code is a one-time code for performing payment applied with a coupon. Alternatively, the display control unit 323 may implicitly recognize that the one-time code is the one-time code for performing payment applied with a coupon because the message is a response message corresponding to the message transmitted in the processing procedure of step S111.

Note that, in the processing procedure of step S112, the issuing unit 314 of the server 110 may issue a new one-time code and generate a new two-dimensional code. The generated new two-dimensional code may be transmitted from the server 110 to the terminal 120 in the processing procedure of step S114. The display control unit 323 of the terminal 120 may display the received new two-dimensional code on the settlement screen as it is. At this time, the issuing unit 314 of the server 110 may issue the one-time code for performing payment applied with a coupon such that a display form associated with the one-time code for performing payment applied with a coupon (i.e., a display form of the settlement screen on which a two-dimensional code applied with a coupon is displayed) and a display form associated with the one-time code for performing payment not applied with a coupon (i.e., a display form of the settlement screen on which the two-dimensional code not applied with a coupon is displayed) are different. For example, the issuing unit 314 may include, in the one-time code for performing payment applied with a coupon, information for instructing a display form to the terminal 120.

In step S116, the POS terminal 130 scans the two-dimensional code displayed on the settlement screen of the terminal 120 and decodes an image of the scanned two-dimensional code to convert the two-dimensional code into a one-time code.

In step S117, the POS terminal 130 transmits settlement information including the decoded one-time code and a payment amount of commodities and the like purchased by the user to the server 110.

In step S118, the settlement processing unit 315 of the server 110 accesses the user management DB using, as a key, the one-time code included in the settlement information and confirms whether a record in which the same one-time code as the one-time code included in the settlement information is stored is present. If the record in which the same one-time code is stored is present, the settlement processing unit 315 acquires a user ID corresponding to the one-time code. The settlement processing unit 315 acquires a coupon ID of the applied coupon by accessing the coupon management DB using, as a key, the one-time code included in the settlement information.

In step S119, the settlement processing unit 315 of the server 110 acquires a discount amount, an expiration period, and a used coupon flag by accessing the coupon management DB using the acquired coupon ID as a key. When the expiration period has not expired and a flag is not set in the used coupon flag, the settlement processing unit 315 subtracts the discount amount from the payment amount included in the settlement information.

In step S120, the settlement processing unit 315 of the server 110 subtracts, from the “balance” of a record of the specified user ID in the user management DB, a payment amount obtained by subtracting the discount amount. Subsequently, the settlement processing unit 315 sets a flag in the “used coupon flag” of the coupon management DB. The settlement processing unit 315 deletes the one-time code included in the settlement information from the user management DB and the coupon management DB (i.e., invalidates the one-time code used for the settlement).

In step S121, the settlement processing unit 315 of the server 110 notifies the POS terminal 130 that the settlement is completed.

In step S122, the settlement processing unit 315 of the server 110 notifies the terminal 120 that the settlement is completed. The notification includes a payment amount after the discount.

In step S123, the display control unit 323 of the terminal 120 displays the settlement completion and the payment amount on the settlement screen.

### <Display Form Concerning the Terminal According to the First Embodiment>

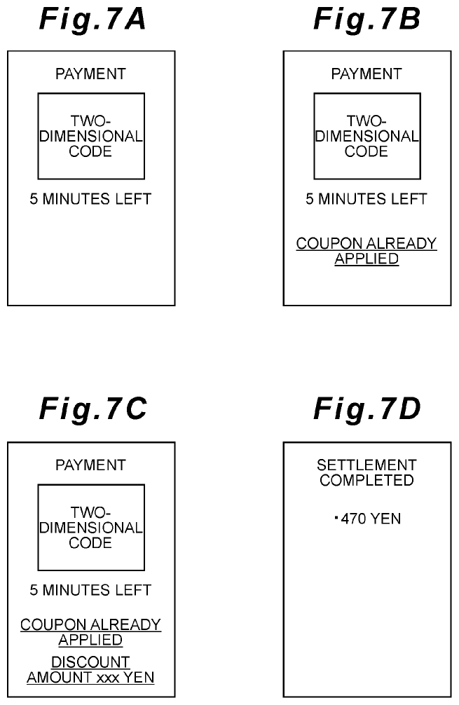

FIGS. 7A to 7D show examples of settlement screens displayed on the terminal 120 according to the first embodiment. FIG. 7A shows an example of a settlement screen displayed when payment is performed without applying a coupon. The settlement screen corresponds to the settlement screen displayed in the processing procedure of step S104 in FIG. 6.

FIGS. 7B and 7C show examples of the settlement screen displayed when payment is performed by applying a coupon. The settlement screen corresponds to the settlement screen displayed in the processing procedure of step S115 in FIG. 6. A message indicating that the coupon is applied is displayed on the settlement screen shown in FIGS. 7B and 7C. Therefore, it is possible to explicitly notify the user that the coupon is applied. Note that, instead of or in addition to the message indicating that the coupon is applied, a two-dimensional code may be displayed in a color different from a color of a two-dimensional code displayed when payment is performed without applying a coupon. FIG. 7D shows an example of a settlement screen during settlement completion. A payment amount after discount is displayed on the settlement screen.

### First Example

In the processing procedure explained with reference to FIG. 6, when a one-time code for performing payment without applying a coupon is already issued before the one-time code for performing payment by applying a coupon is issued, the one-time code (the two-dimensional code) may not be changed (may be repeatedly used). In this case, the server 110 omits the processing procedure of step S112 and performs processing procedures explained below in steps S113 and S114.

In step S113, the issuing unit 314 of the server 110 stores the one-time code issued in the processing procedure of step S102 in the “one-time code” of the selected coupon in the coupon management DB. The issuing unit 314 of the server 110 updates the expiration period stored in the user management DB.

In step S114, the communication unit 312 of the server 110 transmits the one-time code issued in the processing procedure of step S102 and the updated expiration period to the terminal 120.

In the processing procedure explained above, the coupon ID of the coupon applied during payment may be embedded in the one-time code. In this case, in the processing procedure of step S112, the issuing unit 314 of the server 110 issues a new one-time code embedded with the coupon ID. In the processing procedure of step S118, the settlement processing unit 315 of the server 110 specifies a coupon ID of the applied coupon by acquiring a coupon ID from the one-time code received from the POS terminal 130 in the processing procedure of step S117.

### Second Example

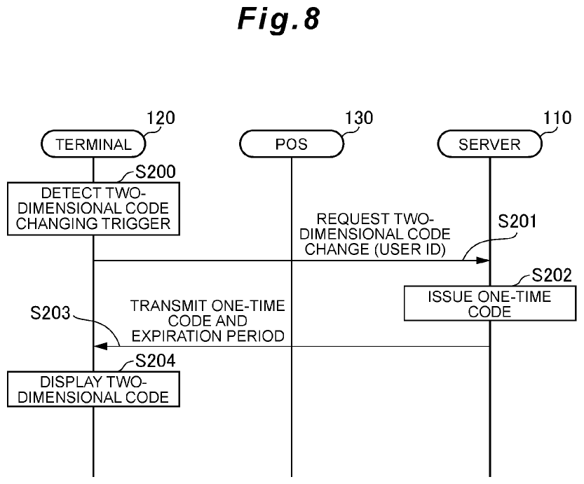

In the first embodiment, a change of the two-dimensional code displayed on the screen of the terminal 120 may be enabled at timing different from the timing during the coupon application. FIG. 8 is an example of a sequence showing a processing procedure in changing a two-dimensional code displayed on the screen of the terminal 120. The sequence shown in FIG. 8 is performed when the detecting unit 324 of the terminal 120 detects a trigger with which a two-dimensional code displayed on the settlement screen should be changed is detected.

In step S200, the detecting unit 324 of the terminal 120 detects a trigger with which a two-dimensional code displayed on the settlement screen should be changed. For example, the trigger may include, not as limitations but as examples, acquisition of a screen shot, predetermined button operation, operation of a specific application in the terminal 120, and detection of specific sound (e.g., photographing sound emitted from a smartphone of another person) via a microphone included in the terminal 120.

In step S201, the communication unit 322 of the terminal 120 transmits a message for requesting a change of the two-dimensional code to the server 110. The message includes a user ID.

In step S202, the issuing unit 314 of the server 110 issues a new one-time code and updates a one-time code stored in the “one-time code” of a record of the user ID notified in step S201 in the user management DB to the new one-time code. At this time, the “expiration period” may be updated or may not be updated. When the one-time code before the update is stored in the “one-time code” of the coupon management DB as well, the issuing unit 314 updates the one-time code to a new one-time code.

In step S203, the communication unit 312 of the server 110 transmits the new one-time code and the expiration period to the terminal 120.

In step S204, the display control unit 323 of the terminal 120 generates a two-dimensional code from the received one-time code and replaces the two-dimensional code already displayed on the settlement screen with the generated two-dimensional code.

Consequently, when, for example, an act likely to cause leakage of the two-dimensional code to the outside is detected, the one-time code is updated. Therefore, it is possible to suppress a security risk that, for example, the two-dimensional code leaks to the outside and illegally used by others.

### Third Example

In the first embodiment, the two-dimensional code may be periodically changed (i.e., the two-dimensional code may be a dynamic two-dimensional code).

### Fourth Example

In the first embodiment, when the two-dimensional code is not changed (is repeatedly used) in applying a coupon and the detecting unit 324 of the terminal 120 detects a trigger with which the two-dimensional code displayed on the settlement screen should be changed, by executing the processing procedures of steps S201 to S204 in FIG. 8 at timing when the trigger is detected, the two-dimensional code displayed on the settlement screen may be changed to a two-dimensional code for performing payment by applying a coupon. Consequently, the processing procedure for changing the two-dimensional code is performed only when, for example, there is a risk that the two-dimensional code is illegally used. Therefore, it is possible to reduce a processing load compared with when the change of the two-dimensional code is performed during the coupon application.

### Second Embodiment

In a second embodiment, the server 110 extracts, among one or more coupons owned by a user who uses the terminal 120, a coupon usable in stores present around a position indicated by position information of the terminal 120 and notifies the coupon to the terminal 120. The terminal 120 displays the coupon notified from the server 110 on the screen to make it known to the user that the user can use the coupon in the neighboring stores. Note that the second embodiment may be combined with the first embodiment. In other words, the coupon in the second embodiment may be a coupon usable for the two-dimensional code settlement. In the following explanation, the explanation is based on the premise that the second embodiment is combined with the first embodiment.

In future, when a settlement act is facilitated by spread of QR code settlement, it is assumed that provision of online coupons usable during settlement is actively performed. When the provision of the online coupons is actively performed, it is assumed that a user owns a large number of coupons in a terminal and has trouble in finding usable coupons. According to the second embodiment, it is possible to notify the user of coupons usable in neighboring stores among the coupons owned by the user. Therefore, it is possible to improve convenience for the user.

According to the second embodiment, it is possible to automatically apply, during payment, a coupon satisfying a predetermined condition among the coupons usable in the neighboring stores. Therefore, it is possible to improve convenience for the user.

By collectively performing the automatic application of the coupon and settlement processing, processing speed in executing selection of a coupon to the settlement processing is improved. Further, troublesome screen operation for selecting a coupon and displaying the coupon on a screen and then displaying a two-dimensional code on the screen is unnecessary. Therefore, an effect is obtained that payment processing is smoothly performed.

### <Configuration in the Second Embodiment>

### (1) Configuration of the Server

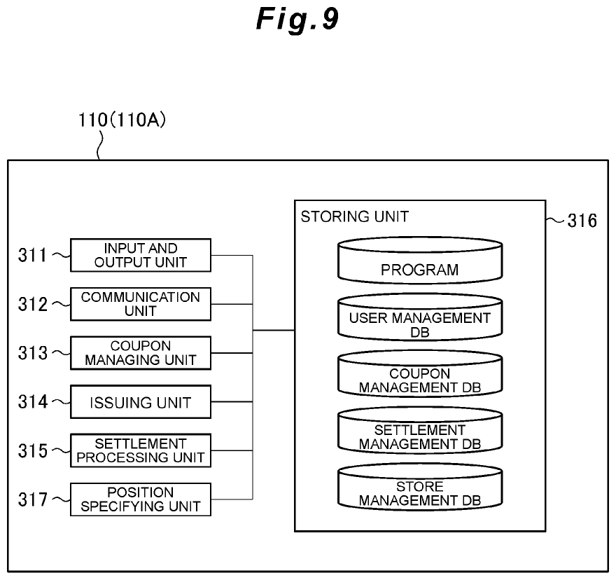

A configuration of the server 110 is explained with reference to FIG. 9. Each unit disclosed in FIG. 9 are realized by cooperation of the processor 201, the memory 202, the storage 203, the input and output I/F 204, and the communication I/F 205 included in the information processing device 200. In the configuration of the server 110, points not particularly referred to may be the same as the points in the first embodiment.

The storing unit 316 stores programs executed by the server 110 according to the second embodiment, a user management DB, a coupon management DB, a settlement management DB, and a store management DB that stores information concerning positions of stores.

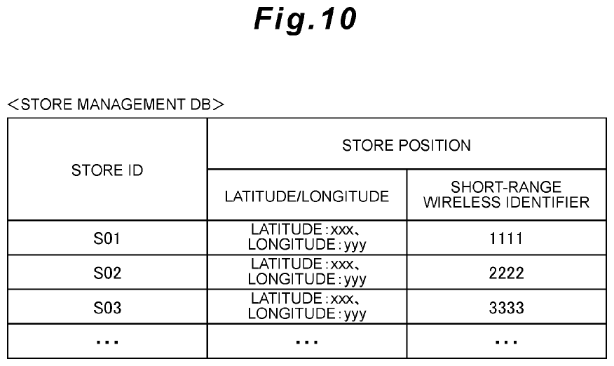

An example of the store management DB is shown in FIG. 10. An ID for specifying a store is stored in “store ID”. Information indicating a position where the store is present is stored in “store position”. In the example shown in FIG. 10, the position where the store is present may be, not as a limitation but as an example, represented by latitude and longitude or represented by a wireless identifier included in a wireless signal transmitted by a wireless device set in the store. Note that a short-range wireless identifier may include, not as limitations by as examples, a beacon ID included in a beacon transmitted by a BLE (Bluetooth Low Energy) device, an SSID included in a wireless signal transmitted by a WiFi (registered trademark) device, and any identification information included in an ultrasonic wave.

The communication unit 312 receives position information of the terminal 120 from the terminal 120. The communication unit 312 transmits information indicating a coupon usable in the neighborhood of the user extracted by the coupon managing unit 313 to the terminal 120. The communication unit 312 receives, as the position information of the terminal 120, a short-range wireless identifier received by the terminal 120.

A position specifying unit 317 specifies a position of the terminal 120 based on the position information of the terminal 120 notified from the terminal 120. For example, when acquiring, from the terminal 120, position information (e.g., latitude and longitude) directly indicating the position of the terminal 120, the position specifying unit 317 specifies the position indicated by the position information as the position of the terminal 120. On the other hand, when acquiring, from the terminal 120, position information (specifically, a short-range wireless identifier) indirectly indicating the position of the terminal 120, the position specifying unit 317 retrieves a store corresponding to the short-range wireless identifier acquired from the store management information and specifies the position of the retrieved store as the position of the terminal 120.

The coupon managing unit 313 extracts, among one or more coupons owned by the user, a coupon usable within a predetermined range from the position of the terminal 120 specified by the position specifying unit 317. The coupon managing unit 313 may extract a coupon usable in a store present within the predetermined range from the specified position of the terminal 120. When the position information of the terminal 120 notified from the terminal 120 is position information (a short-distance wireless identifier) indirectly indicating the position of the terminal 120, the coupon managing unit 313 may set, as “a coupon usable by the terminal 120 within a predetermined range from the position of the terminal 120”, a coupon usable in a store specified as the position of the terminal 120.

### (2) Configuration of the Terminal

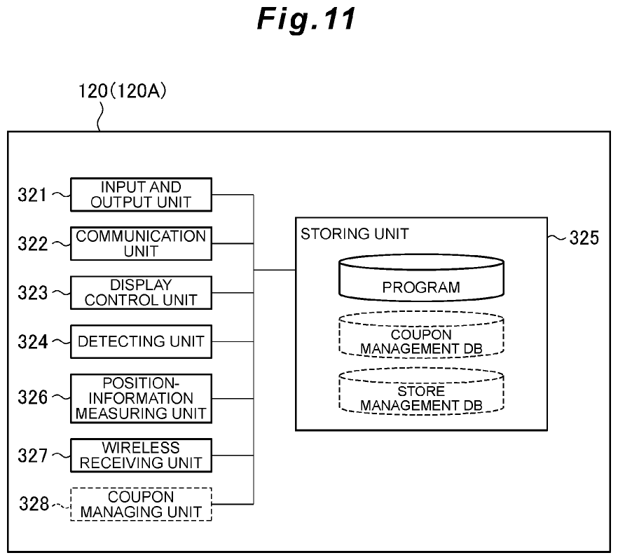

A configuration of the terminal 120 is explained with reference to FIG. 11. Each unit disclosed in FIG. 11 are realized by cooperation of the processor 201, the memory 202, the storage 203, the input and output I/F 204, and the communication I/F 205 included in the information processing device 200. In the configuration of the terminal 120, points not particularly referred to may be the same as the points in the first embodiment.

The terminal 120 further includes a position-information measuring unit 326 and a wireless receiving unit 327. The position-information measuring unit 326 and the wireless receiving unit 327 are realized by the processor 201 reading out and executing programs stored in the storing unit 325.

The communication unit 322 transmits position information of the terminal 120 measured by the position-information measuring unit 326 or a short-range wireless identifier detected by the wireless receiving unit 327 to the server 110. The communication unit 322 receives, from the server 110, information indicating, among one or more coupons owned by the user, a coupon usable in a store present within a predetermined range from a position indicated by the position information of the terminal 120.

The storing unit 325 further stores a coupon management DB and a store management DB. In the coupon management DB, the same record as a record concerning, among records in the coupon management DB stored in the server 110, coupons owned by the user who uses the terminal 120 is stored. The store management DB is the same as the store management DB stored in the server 110. Note that, when the server 110 performs extraction processing of a coupon based on the position information, the coupon management DB and the store management DB may not be stored in the storing unit 325.

The display control unit 323 displays, on a screen, the information indicating the usable coupon received by the communication unit 322.

The position-information measuring unit 326 acquires position information of a present position of the terminal 120. The position-information measuring unit 326 measures latitude and longitude of the terminal 120 as the position information of the present position of the terminal 120 using, not as a limitation but as an example, a GPS (Global Positioning System). Note that the measurement of the position information of the terminal 120 by the position-information measuring unit 326 is not limited to the GPS. Any method may be used for the measurement. The position-information measuring unit 326 may measure position information of the terminal 120 using, not as a limitation but as an example, a wireless LAN such as Wi-Fi. Besides, the position-information measuring unit 326 may measure the position information of the terminal 120 using, not as limitations but as examples, communication schemes such as an IMES (Indoor MEssaging System), an RFID (Radio Frequency Identifier), and a BLE (Bluetooth Low Energy). The position-information measuring unit 326 may measure the position information of the terminal 120 using, not as limitations but as examples, mobile communication systems such as an LTE and a CDMA.

The wireless receiving unit 327 extracts (detects) a short-range wireless identifier from the received short-range wireless signal when receiving a short-range wireless signal.

The coupon managing unit 328 extracts, among one or more coupons owned by the user, a coupon usable within a predetermined range from the position of the terminal 120. The coupon managing unit 328 may specify a store present within the predetermined range from the position of the terminal 120 by retrieving a store corresponding to the short-range wireless identifier from the store management DB. Note that, when the server 110 performs extraction processing of a coupon based on position information, the terminal 120 may not include the coupon managing unit 328.

### <Operation Processing in the Second Embodiment>

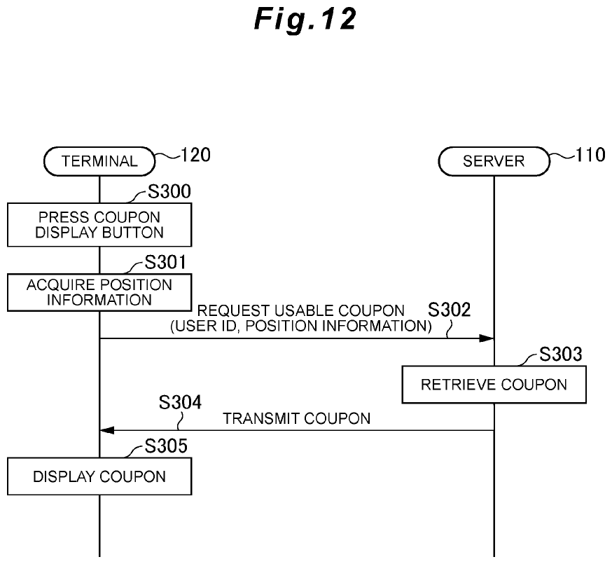

Processing of the communication system 1 according to the second embodiment is explained with reference to FIG. 12. FIG. 12 shows an example of a sequence of a processing procedure performed by the communication system 1 according to the second embodiment.

In step S300, the input and output unit 321 of the terminal 120 receives, from the user, pressing (tap) of a button for displaying the coupon list screen. Naturally, step S300 may be omitted.

In step S301, the position-information measuring unit 326 of the terminal 120 measures position information of the terminal 120. Note that the wireless receiving unit 327 of the terminal 120 may detect a short-range wireless identifier by searching for a short-range wireless signal.

In step S302, the communication unit 322 of the terminal 120 transmits a message for requesting a usable coupon to the server 110. The message includes a user ID and the position information (the position information of the terminal 120 or the short-range wireless identifier) acquired in the processing procedure of step S301.

In step S303, the position specifying unit 317 of the server 110 specifies a position of the terminal 120 based on the position information received from the terminal 120. Subsequently, the coupon managing unit 313 accesses the store management DB and extracts a store present within a predetermined range from the specified position of the terminal 120. The predetermine range is optional but may be, not as limitations but as examples, 100 m or less, 500 m or less, 1 km or less, and the like. If the position information notified in the processing procedure of step S302 is the short-range wireless identifier, the coupon managing unit 313 may regard, as “the store present within the predetermined range from the specified position of the terminals 120”, a store corresponding to the position of the terminal 120 specified by the position specifying unit 317. Subsequently, the coupon managing unit 313 accesses the coupon management DB to extract, among the coupons owned by the user, coupons in which a store ID of the extracted store is included in a coupon usable store ID.

In step S304, the communication unit 312 of the server 110 transmits the extracted coupons to the terminal 120. Specifically, the communication unit 312 transmits coupon IDs, discount amounts, expiration periods, and coupon usable store IDs of the extracted coupons to the terminal 120.

In step S305, the display control unit 323 of the terminal 120 displays the coupon list screen. Coupon usable stores, discount amounts, expiration periods, and the like are displayed for each of the coupons on the coupon list screen.

Note that the processing procedures of steps S300 to S305 in FIG. 12 can be incorporated in the processing procedures of steps S105 to S109 in FIG. 6. In other words, after the processing procedure of step S305, the processing procedures of step S110 and subsequent steps in FIG. 6 may be performed.

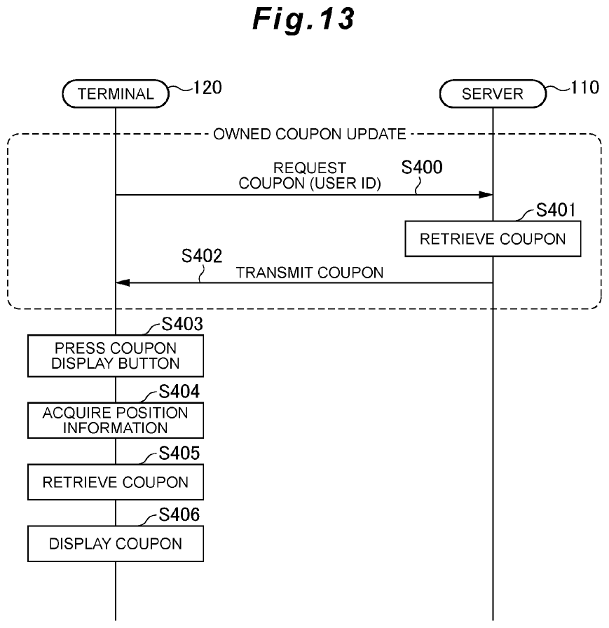

FIG. 13 shows an example of a sequence of a processing procedure performed by the communication system 1 according to the second embodiment. As shown in FIG. 13, in the second embodiment, instead of the server 110, the terminal 120 may perform extraction processing of a coupon based on position information.

In step S400, the coupon managing unit 328 of the terminal 120 transmits a message for requesting information of a coupon to the server 110 in order to update the coupon management DB of the terminal 120. The message includes a user ID.

In step S401, the coupon managing unit 313 of the server 110 accesses the coupon management DB and retrieves all records corresponding to the received user ID.

In step S402, the communication unit 312 of the server 110 transmits data included in the retrieved records in the coupon management DB to the terminal 120.

Note that the processing procedures of steps S400 to S402 may be executed when the coupons owned by the user are updated or may be periodically performed.

Explanation of the processing procedures of steps S403 and S404 is omitted because the processing procedures are the same as the processing procedures of steps S300 and S301 in FIG. 12.

In step S405, the coupon managing unit 328 of the terminal 120 accesses the store management DB and extracts a store present within a predetermined range from the position of the terminal 120. If the position information notified in the processing procedure of step S302 is the short-range wireless identifier, the coupon managing unit of the terminal 120 accesses the store management DB and extracts a store corresponding to the same short-range wireless identifier as the notified short-range wireless identifier. Subsequently, the coupon managing unit 328 of the terminal 120 accesses the coupon management DB and extracts, among the coupons owned by the user, coupons in which a store ID of the extracted store is included in a coupon usable store ID.

In step S406, the display control unit 323 of the terminal 120 displays the extracted coupons on the coupon list screen. Coupon usable stores, discount amount, expiration periods, and the like are displayed for each of the coupons on the coupon list screen.

Note that the processing procedures of steps S403 to S406 in FIG. 13 can be incorporated in the processing procedures of steps S105 to S109 in FIG. 6. The processing procedures of step S110 and subsequent steps in FIG. 6 may be performed after the processing procedure of step S406.

### First Example

In the second embodiment explained above, when a plurality of usable coupons are present in the processing procedure of step S305 in FIG. 12 or step S406 in FIG. 13, the display control unit 323 may receive, from the user, selection of a coupon to be used or may select one coupon satisfying a predetermined condition. The predetermined condition may be, not as limitations but as examples, a coupon having the highest (or lowest) discount amount (or discount rate) and a coupon, an expiration period of which is within a predetermined period. The coupon, the expiration period of which is within the predetermined period, may be a coupon having a close (or far) expiration period such as one month or less or three months ahead. Thereafter, the processing procedures of steps S111 to S114 in FIG. 6 are executed. The display control unit 323 displays a two-dimensional code for performing payment by applying the selected coupon (S115). Consequently, when the plurality of usable coupons are present, it is possible to automatically select a coupon.

### Second Example

In the second embodiment explained above, when a plurality of coupons retrieved in step S303 in FIG. 12 are present (i.e., a plurality of usable coupons are present), the issuing unit 314 of the server 110 may select one coupon satisfying the predetermined condition and execute the payment processing in the first embodiment by automatically applying the selected coupon. Specifically, the issuing unit 314 may regard the selected coupon as a coupon selected by the user and perform the processing procedure of step S113 in FIG. 6. Alternatively, the settlement processing unit 315 may perform the payment processing by applying the selected coupon and perform the processing procedures of steps S119 and S120 in FIG. 6. The user may be capable of optionally setting whether a coupon is automatically applied. Since the coupon is automatically selected, the user is capable of using the coupon without wasting the coupon.

### Third Embodiment

A third embodiment is an embodiment that, when a coupon having a close expiration period is present among a plurality of coupons owned by a user (associated with the user), makes it possible to transfer the coupon having the close expiration period to another user for whom a predetermined relation is set. The predetermined relation being set means a state in which users are registered as establishing the predetermined relation in the server 110. The state in which the predetermined relation is established may include, not as limitations but as examples, a state in which the users approve relation establishment each other, a state in which at least one of the users proposes the relation establishment, a state in which the relation establishment is performed based on user information, and a state in which the relation establishment is performed according to the predetermined condition. In the following explanation, for convenience of explanation, the predetermined relation being set between the users is expressed that the users are in a friend relation. Note that the third embodiment can be combined with the first or second embodiment. In other words, the coupon in the third embodiment may be a coupon usable for the two-dimensional code settlement. In the following explanation, the explanation is based on the premise that the third embodiment is combined with at least the first embodiment.

When a settlement act is facilitated by spread of QR code settlement, it is assumed that provision of online coupons usable during settlement is actively performed. When the provision of the online coupons is actively performed, it is assumed that a user cannot use a coupon owned by the user before an expiration period and the coupon is wasted. According to the third embodiment, the user can transfer a coupon having a close expiration period among coupons owned by the user to a user in a friend relation. Therefore, it is possible to reduce likelihood that the coupon is wasted without being used.

### <Configuration of the Third Embodiment>

### (1) Configuration of the Server

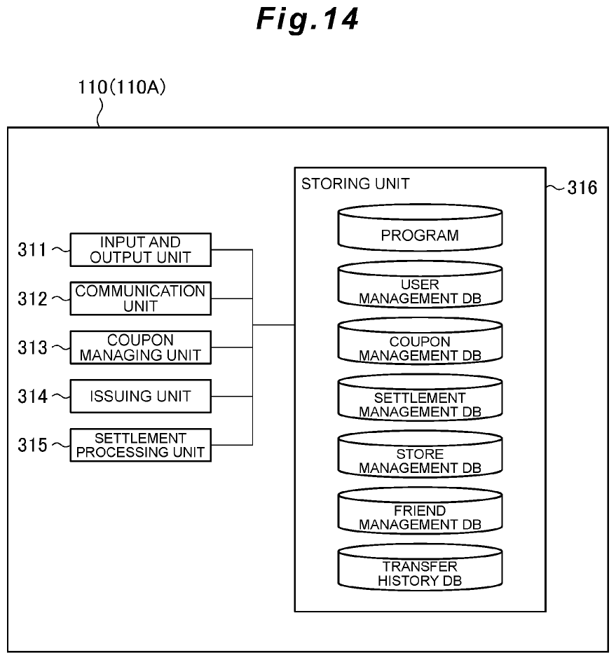

A configuration of the server 110 is explained with reference to FIG. 14. Each unit disclosed in FIG. 14 are realized by cooperation of the processor 201, the memory 202, the storage 203, the input and output I/F 204, and the communication I/F 205 included in the information processing device 200. In the configuration of the server 110, points not particularly referred to may be the same as the points in the first or second embodiment. In the configuration of the server 110, the server 110 may include one of the units not shown in FIG. 14 but included in the second embodiment.

The storing unit 316 further stores a friend management DB for managing a friend relation among users and a assign history DB for recording from which user to which user a coupon is transferred.

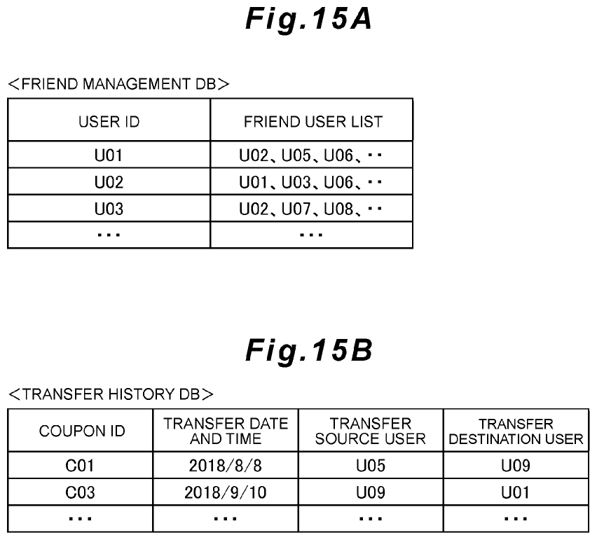

An example of the friend management DB is shown in FIG. 15A. An ID for specifying a user is stored in “user ID”. One or more user IDs of users in a friend relation are stored in “friend user list”.

An example of the assign history DB is shown in FIG. 15B. An ID for specifying a coupon is stored in the “coupon ID”. A date and time when the coupon is transferred is stored in “assign date and time”. A user ID of an assigner user and a user ID of an assignee user (a current owner) are respectively stored in “assigner user” and “assignee user”.

The communication unit 312 transmits, to the terminal 120, information indicating a coupon, an expiration period of which expires within a predetermined period (the expiration period is set within the predetermined period) (a first transmitting unit). The communication unit 312 transmits, to the terminal 120, information indicating a user in a friend relation with a user who uses the terminal 120 (a second transmitting unit). The communication unit 312 receives, from the terminal 120, information indicating a user as an assignee of the coupon, the expiration period of which expires within the predetermined period.

The coupon managing unit 313 extracts (specifies), among one or more coupons owned by the user who uses the terminal 120, a coupon, an expiration period of which expires within the predetermined period, and a user in a friend relation with the user (an extracting unit (a specifying unit)). The coupon managing unit 313 changes an owner of the coupon, the expiration period of which expires within the predetermined period, from the user who uses the terminal 120 to the user to be assigned as an assignee of the coupon. (a managing unit) When changing the owner of the coupon, the expiration period of which expires within the predetermined period, the coupon managing unit 313 records the assigner user and the assignee user in the assign history DB (a history of change).

### (2) Configuration of the Terminal

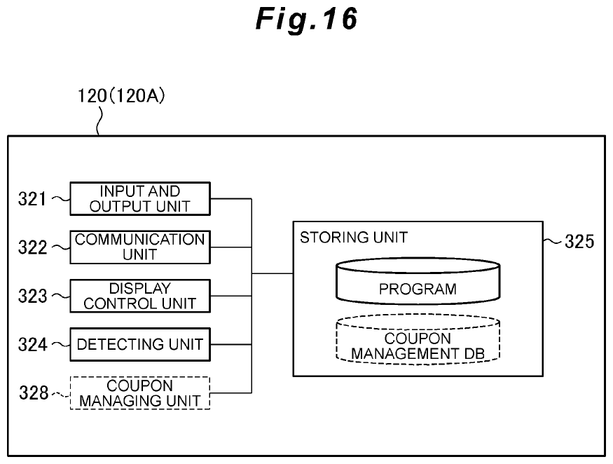

A configuration of the terminal 120 is explained with reference to FIG. 16. Each unit disclosed in FIG. 16 are realized by cooperation of the processor 201, the memory 202, the storage 203, the input and output I/F 204, and the communication I/F 205 included in the information processing device 200. In the configuration of the terminal 120, points not particularly referred to may be the same as the points in the first or second embodiment. In the configuration of the terminal 120, the terminal 120 may include units not shown in FIG. 16 but included in the second embodiment.

The terminal 120 further includes a coupon managing unit 328.

The storing unit 325 further stores a coupon management DB. In the coupon management DB, the same record as a record concerning, among records in the coupon management DB stored in the server 110, coupons owned by the user who uses the terminal 120 is stored.

The coupon managing unit 328 extracts a coupon, an expiration period of which expires within a predetermined period, among one or more coupons owned by the user who uses the terminal 120.

Note that the coupon management DB and the coupon managing unit 328 are unnecessary when the terminal 120 itself does not perform extraction processing of the coupon, the expiration period of which expires within the predetermined period.

### <Operation Processing in the Third Embodiment>

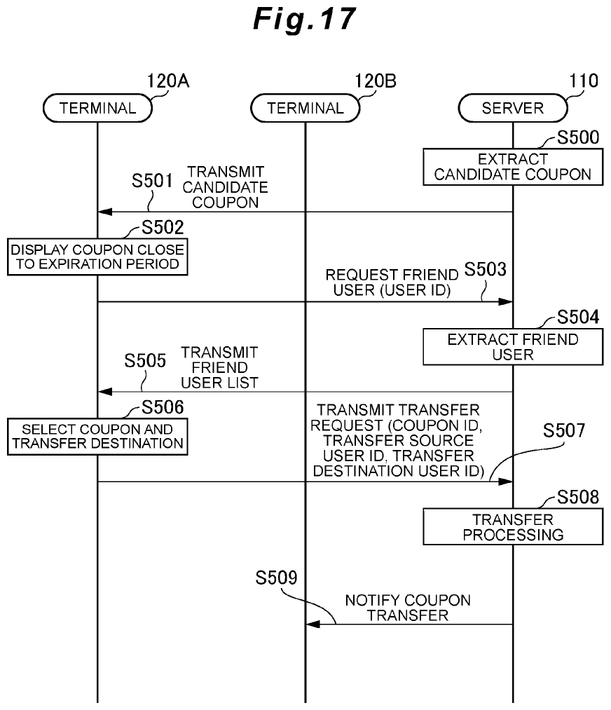

Processing of the communication system 1 according to the third embodiment is explained with reference to FIG. 17. FIG. 17 shows an example of a sequence of a processing procedure performed by the communication system 1 according to the third embodiment. Note that a terminal 120A is a terminal 120 used by a user at an assigner of a coupon and a terminal 120B is the terminal 120 used by a user at an assignee of the coupon.

In step S500, the coupon managing unit 313 of the server 110 searches through the coupon management DB to extract a coupon, an expiration period of which expires within a predetermined period.

In step S501, the communication unit 312 of the server 110 transmits a coupon ID, a discount amount, an expiration period, and a coupon usable store ID of the extracted coupon to the terminal 120A.

In step S502, the display control unit 323 of the terminal 120 displays a message notified from the server 110 indicating that the coupon, the expiration period of which expires within the predetermined period, is present. Note that the display control unit 323 may display the message at predetermined notification timing a predetermined time before the expiration period. When an instruction to the effect that the user desires to transfer the coupon is received from the user, the processing proceeds to a processing procedure of step S503.

In step S503, the communication unit 312 of the terminal 120A transmits a message requesting a list of users in a friend relation to the server 110. The message includes a user ID of a user who uses the terminal 120A.

In step S504, the coupon managing unit 313 of the server 110 accesses the friend management DB and extracts user IDs of users in a friend relation with the user who uses the terminal 120A.

In step S505, the communication unit 312 of the server 110 transmits a message including the extracted users ID of the users in the friend relation to the terminal 120A.

In step S506, the input and output unit 321 of the terminal 120A receives selection of a user to whom the coupon is transferred out of the users displayed on a friend list screen.

In step S507, the communication unit 312 of the terminal 120A transmits a message requesting the transfer of the coupon to the server 110. The message includes a coupon ID, a user ID of an assigner user, and a user ID of an assignee user.

In step S508, the coupon managing unit 313 of the server 110 rewrites the “user ID” of the transferred coupon in the coupon management DB to the user ID of the assignee user. The coupon managing unit 313 records, in the assign history DB, the present date and time and the coupon ID, the user ID of the assigner user, and the user ID of the assignee user received in the processing procedure of step S507.

In step S509, the communication unit 312 of the server 110 notifies the terminal 120B of the assignee user that the coupon has been transferred.

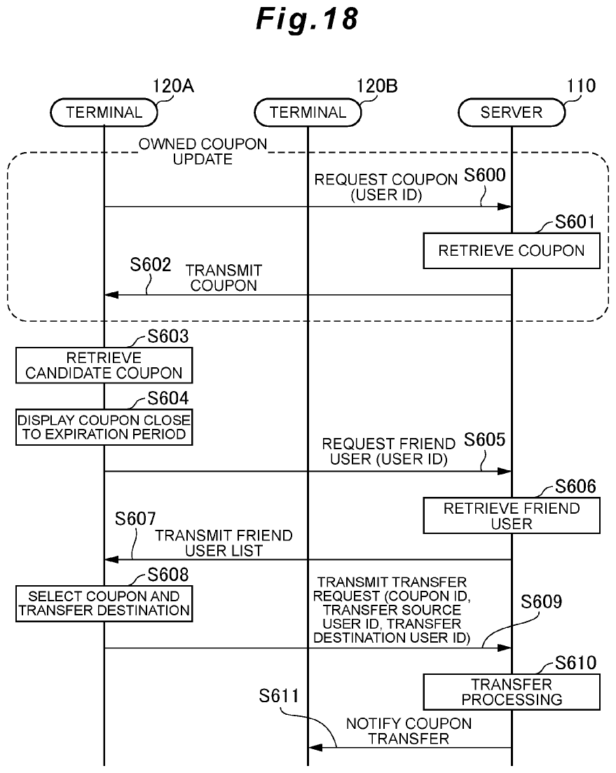

FIG. 18 shows an example of a sequence of a processing procedure performed by the communication system 1 according to the third embodiment. As shown in FIG. 18, in the third embodiment, instead of the server 110, the terminal 120 may perform extraction processing of a coupon having a close expiration period.

Processing procedures of steps S600 to S602 are respectively the same as steps S400 to S402 in FIG. 13. Therefore, explanation of the processing procedures is omitted.

In step S603, the coupon managing unit 328 of the terminal 120 searches through the coupon management DB to extract a coupon, an expiration period of which expires within a predetermined period.

Processing procedures of steps S604 to S611 are respectively the same as the processing procedures of steps S502 to S509 in FIG. 17. Therefore, explanation of the processing procedures is omitted.

### First Example

When changing an owner of a coupon, the coupon managing unit 313 of the server 110 may reduce or increase a discount amount of the coupon (reduce or increase a privilege of the coupon). When changing the owner of the coupon, the coupon managing unit 313 may reduce or extend an expiration period of the coupon. Note that the reduction or the increase of the discount amount of the coupon and the reduction and the extension of the expiration period of the coupon may be set in any way and may include, not as limitations but as examples, setting by a coupon issuer, setting for each coupon issuer, uniform setting, setting according to credibility and intimacy between users who perform a transfer transaction. According to the first example, the coupon issuer can distribute coupons to a larger number of users and the user can prevent owned coupons from being wasted.

### Second Example

When changing an owner of a coupon, an expiration period of which expires within a predetermined period, the coupon managing unit 313 of the server 110 may retrieve owners in the past of the coupon by referring to the assign history DB and, when an assignee user is included in the owners in the past of the coupon, may not change the owner. Consequently, by transferring the coupon among a plurality of users, it is possible to prevent illegal acts of illegally extending the expiration period of the coupon and illegally increasing a discount amount.

### Third Example

When retrieving friend users of an owner of a coupon, the coupon managing unit 313 of the server 110 may select an assignee candidate user based on coupon use histories of the friends and notify the selected user to the terminal 120 of a user who is the owner of the coupon. The coupon managing unit 313 may select, as the an assignee candidate user, not as a limitation but as an example, a user most often using the coupon among the friend users of the owner of the coupon.

### Fourth Example

When transferring a coupon, the coupon managing unit 313 of the server 110 may add an assignee user to an owner of the coupon (a user associated with the coupon). More in detail, the coupon managing unit 313 may add a user ID of an assignee user to the “user ID” of the transferred coupon in the coupon management DB. The coupon managing unit 313 may delete an assigner user from the owner of the coupon at any timing. More in detail, the coupon managing unit 313 may delete a user ID of the assigner user from the coupon management DB at any timing. When adding the an assignee user to the owner of the coupon, the coupon managing unit 313 may record, in the assign history DB, the present date and time, the coupon ID received in the processing procedure of step S507, and the user ID of the an assignee user.

When adding the an assignee user to the owner of the coupon, the coupon managing unit 313 may perform the processing (reducing or increasing the privilege of the coupon and extending the expiration period of the coupon) described in the first example. When adding the an assignee user to the owner of the coupon, as the processing described in the second example, the coupon managing unit 313 may not add the an assignee user to the owner of the coupon, for example, when the an assignee user is included in the owners in the past of the coupon.

### Fourth Embodiment

In a fourth embodiment, coupons having close expiration periods and coupons usable in stores present around a position indicated by position information of the terminal 120 among a plurality of coupons owned by a user are extracted and notified to the terminal 120.

When coupons are provided in all stores in the world, a situation is assumed in which expiration periods of the coupons are always expired in some stores and the coupons are always notified to the terminal 120. Therefore, in the fourth embodiment, only a coupon satisfying an extraction condition set in advance by a user among coupons having close expiration periods and usable in stores present around the position indicated by the position information of the terminal 120 may be notified to the terminal 120.

According to the fourth embodiment, it is possible to notify the user of only a coupon satisfying the extraction condition set by the user among coupons having close expiration periods and usable in neighboring stores among the coupons owned by the user. Therefore, it is possible to avoid a situation in which the coupons are always notified to the terminal 120.

The fourth embodiment can be combined with the first to third embodiments. In other words, the coupon in the fourth embodiment may be a coupon usable for the two-dimensional code settlement. In the following explanation, the explanation is based on the premise that the fourth embodiment is combined with at least the first embodiment.

### <Configuration in the Fourth Embodiment>

### (1) Configuration of the Server

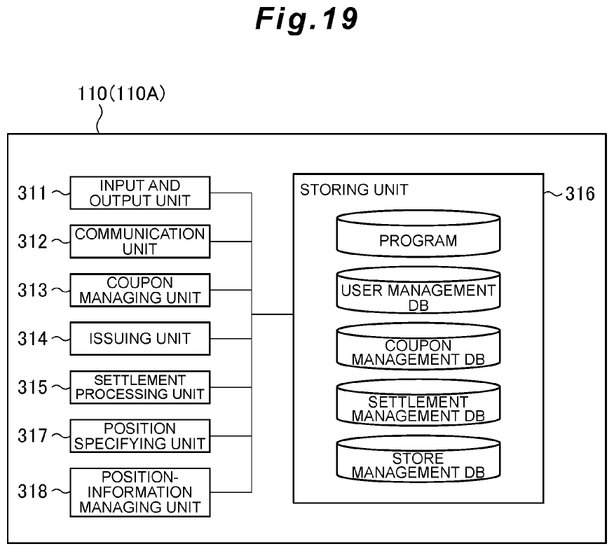

A configuration of the server 110 is explained with reference to FIG. 19. Each unit disclosed in FIG. 19 are realized by cooperation of the processor 201, the memory 202, the storage 203, the input and output I/F 204, and the communication I/F 205 included in the information processing device 200. In the configuration of the server 110, points not particularly referred to may be the same as the points in the first, second, or third embodiment. The storing unit 316 of the server 110 may store a database not shown in FIG. 19 but included in the third embodiment.

The communication unit 312 functions as a transmitting unit that transmits a coupon extracted by the coupon managing unit 313 to the terminal 120.

The coupon managing unit 313 extracts (specifies), among one or more coupons owned by a user, a coupon, an expiration period of which expires within a predetermined period, usable within a predetermined range from the position of the terminal 120 (an extracting unit ((a specifying unit)). Note that the coupon managing unit 313 may further extracts a coupon satisfying an extraction condition (a predetermined condition) set by the user in advance. A specific example of the extraction condition is explained below.

A position-information managing unit 318 acquires position information indicating the position of the terminal 120 via the communication unit 312 to manage the position of the terminal 120. The position-information managing unit 318 stores the received position information of the terminal 120 in a user management DB.

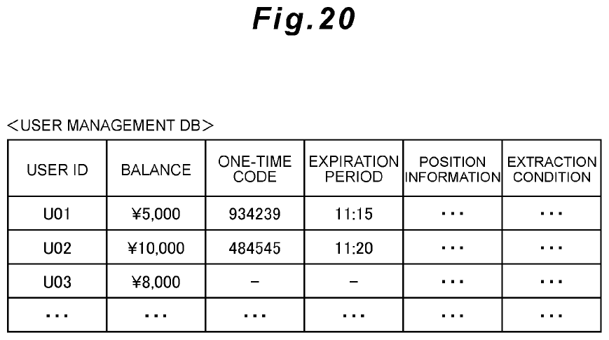

An example of a user management DB according to the fourth embodiment is shown in FIG. 20. Position information of a user (more specifically, position information of the terminal 120 used by the user) is stored in “position information”. Information (e.g., latitude and longitude) indicating a specific position may be stored in the position information. A condition of a coupon set by the user as an extraction target by the coupon managing unit 313 is set in “extraction condition”.

### (2) Configuration of the Terminal

A configuration diagram of the terminal 120 is the same as FIG. 16. Therefore, explanation of the configuration diagram is omitted.

### <Operation Processing in the Fourth Embodiment>

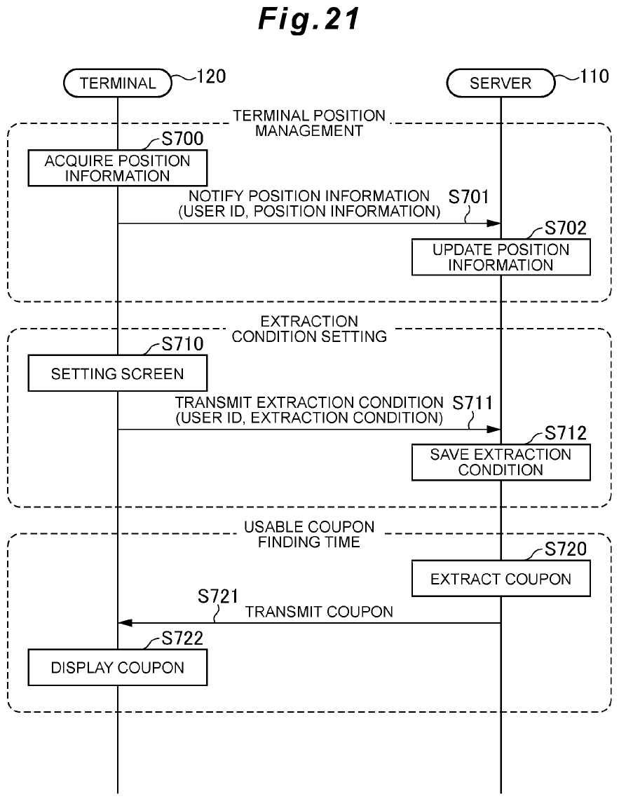

Processing of the communication system 1 according to the fourth embodiment is explained with reference to FIG. 21. FIG. 21 shows an example of a sequence of a processing procedure performed by the communication system 1 according to the fourth embodiment. In FIG. 21, steps S700 to S702 indicate a processing procedure performed when the server 110 manages position information of the terminal 120. The processing procedure of steps S700 to S702 is repeatedly performed in every predetermined period or according to movement of the terminal 120. Steps S710 to S712 indicate a processing procedure performed when the user sets an extraction condition. Steps S720 to S722 indicate a processing procedure performed when a coupon that should be notified to the user is extracted. These three processing procedures are asynchronously performed.

In step S700, the position-information measuring unit 326 of the terminal 120 acquires position information of the terminal 120.

In step S701, the communication unit 322 of the terminal 120 transmits a message for notifying the position information to the server 110. The message includes a user ID and the position information of the terminal 120.

In step S702, the position-information managing unit 318 of the server 110 updates the “position information” of the user management DB to the received position information.

In step S710, the input and output unit 321 of the terminal 120 receives, on a screen for setting an extraction condition, setting of an extraction condition from the user.

In step S711, the communication unit 322 of the terminal 120 transmits a message for notifying the set extraction condition to the server 110.

In step S712, the coupon managing unit 313 of the server 110 stores the received extraction condition in “extraction condition” of the user management DB.

In step S720, the coupon managing unit 313 of the server 110 searches through the coupon management DB to extract a coupon, an expiration period of which expires within a predetermined period. When the coupon is extracted, the coupon managing unit 313 accesses the user management DB and acquires position information of a user who owns the extracted coupon. Subsequently, the coupon managing unit 313 accesses the store management DB and extracts, based on the position information of the user who owns the extracted coupon, a store that is present within a predetermined range from the position of the user (the position of the terminal 120) and where the extracted coupon, the expiration period of which expires within the predetermined period, is usable. The predetermined range is optional but may be, not as limitations but as examples, 100 m or less, 500 m or less, 1 km or less, and the like.

When a usable coupon is extracted, the coupon managing unit 313 further confirms whether the coupon satisfies “extraction condition” set in the user management DB. When the coupon satisfies the “extraction condition”, the coupon managing unit 313 proceeds to a processing procedure of step S721.

The extraction condition may be a condition that a predetermined rank in the coupon is the highest. The predetermined rank may be a rank given to a company that provides the coupon, may be a coupon having a high frequency of use, or may include a rank determined by a money bid by the company that provides the coupon.

The extraction condition may be a condition that the coupon is usable in a range designated by the user. For example, by setting a behavior range of the user as the extraction condition, the user is capable of preventing a coupon that cannot be used in a normal behavior range from being notified.

The extraction condition may be a condition that the number of coupons received by the user is smaller than the number decided by a maximum number of received coupons for each day designated by the user. Since the number of received coupons is decided, it is possible to prevent a large volume of coupons from reaching the terminal 120.

The extraction condition may be a condition that the coupon is usable in a store where the user used the coupon in the past or a store having a predetermined relation with the store. The store having the predetermined relation may be, for example, a chain store or a store of a similar industry type.

In step S721, the communication unit 312 of the server 110 transmits a coupon ID, a discount amount, an expiration period, and a coupon usable store ID of the extracted coupon to the terminal 120.

In step S722, the display control unit 323 of the terminal 120 displays a coupon list screen. Coupon usable stores, discount amounts, expiration periods, and the like are displayed on the coupon list screen.

### <Notes>

### (Note 1-1)

An information processing method executed by a second information processing device that communicates with a first information processing device used by a user, the information processing method comprising:

a first receiving step for receiving, from the first information processing device, a request for a one-time code for performing payment applied with a coupon;

an issuing step for issuing, in response to the request, a first one-time code for performing the payment applied with the coupon;

a transmitting step for transmitting the issued first one-time code to the first information processing device;

a second receiving step for receiving a second one-time code and a payment amount from a third information processing device used by a user who receives payment from the user; and

a settlement processing step for, when the received second one-time code is same as the first one-time code, acquiring, from a database that manages privileges for each coupon, a privilege concerning the coupon used for the payment and settling, as a payment amount paid by the user, an amount calculated based on the acquired privilege and the payment amount.

### (Note 1-2)

The information processing method described in note 1-1, wherein, in the issuing step, when a one-time code for performing payment without applying the coupon is already issued before the first one-time code is issued, the first one-time code is issued such that a display form associated with the first one-time code and a display form associated with the one-time code for performing payment without applying the coupon are different.

### (Note 1-3)

The information processing method described in note 1-1 or 1-2, wherein, in the issuing step, when a one-time code for performing payment without applying the coupon is already issued before the first one-time code is issued, the first one-time code is issued to be a code different from the one-time code.

### (Note 1-4)

The information processing method described in note 1-1 or 1-2, wherein, in the issuing step, when a one-time code for performing payment without applying the coupon is already issued before the first one-time code is issued, the one-time code is used as the first one-time code.

### (Note 1-5)

The information processing method described in any one of notes 1-1 to 1-4, wherein,

in the issuing step, the issued first one-time code is recorded in the database in association with coupon information indicating a coupon applied during payment, and

in the settlement processing step, when the received second one-time code is the same as the first one-time code, the coupon applied during payment is specified by inquiring the database about coupon information associated with the received second one-time code.

### (Note 1-6)

The information processing method described in note 1-3, wherein

in the issuing step, the one-time code including coupon information for specifying a coupon applied during payment is issued, and

in the settlement processing step, when the received second one-time code is same as the first one-time code, the coupon applied during payment is specified by acquiring coupon information from the received second one-time code.

### (Note 1-7)

The information processing method described in any one of notes 1-1 to 1-6, wherein

in the first receiving step, a changing request for a one-time code is received from the first information processing device,

in the issuing step, a third one-time code different from the first one-time code is issued in response to the changing request for the one-time code, the third one-time code being a one-time code for performing the payment applied with the coupon, and

in the transmitting step, the issued third one-time code is transmitted to the first information processing device.

### (Note 1-8)

The information processing method described in any one of notes 1-1 to 1-7, wherein the privilege is a discount amount or a discount rate.

### (Note 1-9)

An information processing device operating as a second information processing device that communicates with a first information processing device used by a user, the information processing device comprising:

a first receiving unit configured to receive, from the first information processing device, a request for a one-time code for performing payment applied with a coupon;

an issuing unit configured to issue, in response to the request, a first one-time code for performing the payment applied with the coupon;

a transmitting unit configured to transmit the issued first one-time code to the first information processing device;

a second receiving unit configured to receive a second one-time code and a payment amount from a third information processing device used by a user who receives payment from the user; and

a settlement processing unit configured to, when the received second one-time code is same as the first one-time code, acquire, from a database that manages privileges for each coupon, a privilege concerning the coupon used for the payment and settle, as a payment amount paid by the user, an amount calculated based on the acquired privilege and the payment amount.

### (Note 1-10)

A program for causing a second information processing device, the second information processing device communicating with a first information processing device used by a user, to execute:

a first receiving step for receiving, from the first information processing device, a request for a one-time code for performing payment applied with a coupon;

an issuing step for issuing, in response to the request, a first one-time code for performing the payment applied with the coupon;

a transmitting step for transmitting the issued first one-time code to the first information processing device;

a second receiving step for receiving a second one-time code and a payment amount from a third information processing device used by a user who receives payment from the user; and

a settlement processing step for, when the received second one-time code is same as the first one-time code, acquiring, from a database that manages privileges for each coupon, a privilege concerning the coupon used for the payment and settling, as a payment amount paid by the user, an amount calculated based on the acquired privilege and the payment amount.

### (Note 1-11)

A display program for causing a first information processing device that communicates with a second information processing device, the first information processing device being used by a user, to execute:

a transmitting step for transmitting, to the second information processing device, a request for a one-time code for performing payment applied with a coupon;

a receiving step for receiving a first one-time code from the second information processing device; and

a displaying step for replacing a two-dimensional code displayed on a two-dimensional code display screen with a two-dimensional code corresponding to the received first one-time code and displaying the two-dimensional code.

### (Note 1-12)

The display program described in note 1-11, wherein, in the displaying step, information indicating a two-dimensional code for performing the payment applied with the coupon is displayed on the two-dimensional code display screen.

### (Note 1-13)

An information processing method executed by a first information processing device that communicates with a second information processing device, the first information processing device being used by a user, the information processing method comprising:

a transmitting step for transmitting, to the second information processing device, a request for a one-time code for performing payment applied with a coupon;

a receiving step for receiving a first one-time code from the second information processing device; and

a displaying step for replacing a two-dimensional code displayed on a two-dimensional code display screen with a two-dimensional code corresponding to the received first one-time code and displaying the two-dimensional code.

### (Note 1-14)

An information processing device functioning as a first information processing device that communicates with a second information processing device, the first information processing device being used by a user, the information processing device comprising:

a transmitting unit configured to transmit, to the second information processing device, a request for a one-time code for performing payment applied with a coupon;

a receiving unit configured to receive a first one-time code from the second information processing device; and

a displaying unit configured to replace a two-dimensional code displayed on a two-dimensional code display screen with a two-dimensional code corresponding to the received first one-time code and display the two-dimensional code.

### (Note 2-1)

An information processing method executed by a second information processing device that communicates with a first information processing device used by a user, the information processing method comprising:

a first issuing step for issuing a first one-time code for performing payment without applying a coupon;

a specifying step for specifying a position of the first information processing device;

an extracting step for extracting, among one or more coupons owned by the user, coupons usable within a predetermined range from the specified position of the first information processing device;

a transmitting step for transmitting the extracted usable coupons to the first information processing device; and

a second issuing step for issuing a second one-time code for performing payment by applying a coupon selected by the user among the usable coupons, the second one-time code being different from the first one-time code.

### (Note 2-2)

The information processing method described in note 2-1, further comprising:

a transmitting step for transmitting the issued second one-time code to the first information processing device;

a receiving step for receiving a third one-time code and a payment amount from a third information processing device used by a user who receives payment from the user; and

a settlement processing step for, when the received third one-time code is same as the second one-time code, acquiring, from a database that manages privileges for each coupon, a privilege concerning the coupon used for the payment and settling, as a payment amount paid by the user, an amount calculated based on the acquired privilege and the payment amount.

### (Note 2-3)

The information processing method described in note 2-1 or 2-2, wherein, in the specifying step, a short-range wireless identifier received by the first information processing device is acquired from the first information processing device and a position of the first information processing device is specified by retrieving a store corresponding to the acquired short-range wireless identifier from a database that associates short-range wireless identifiers and stores.

### (Note 2-4)

An information processing device operating as a second information processing device that communicates with a first information processing device used by a user, the information processing device comprising:

an issuing unit configured to issue a first one-time code for performing payment without applying a coupon;

a specifying unit configured to specify a position of the first information processing device;

an extracting unit configured to extract, among one or more coupons owned by the user, coupons usable within a predetermined range from the specified position of the first information processing device; and

a transmitting unit configured to transmit the extracted usable coupons to the first information processing device; wherein

the issuing unit issues a second one-time code for performing payment by applying a coupon selected by the user among the usable coupons, the second one-time code being different from the first one-time code.

### (Note 2-5)

A program for causing a second information processing device, the second information processing device communicating with a first information processing device used by a user, to execute:

a first issuing step for issuing a first one-time code for performing payment without applying a coupon;

a specifying step for specifying a position of the first information processing device;

an extracting step for extracting, among one or more coupons owned by the user, coupons usable within a predetermined range from the specified position of the first information processing device;

a transmitting step for transmitting the extracted usable coupons to the first information processing device; and

a second issuing step for issuing a second one-time code for performing payment by applying a coupon selected by the user among the usable coupons, the second one-time code being different from the first one-time code.

### (Note 2-6)

A program for causing a first information processing device used by a user to execute:

a first displaying step for displaying a first two-dimensional code for performing payment without applying a coupon;

a transmitting step for transmitting position information of the first information processing device to a second information processing device;

a receiving step for receiving, from the second information processing device, information indicating, among one or more coupons associated with the user, coupons usable within a predetermined range from a position of the first information processing device;

a second displaying step for displaying the received usable coupons on a screen; and

a third displaying step for displaying a second two-dimensional code for performing payment by applying the usable coupons, the second two-dimensional code being different from the first two-dimensional code.

### (Note 2-7)

The program described in note 2-6, wherein, in the third displaying step, a second two-dimensional code for performing payment by applying a coupon designated in response to operation by the user among the usable coupons is displayed.

### (Note 2-8)

The program described in note 2-6 or 2-7, wherein, in the second displaying step, when a plurality of the usable coupons are present within a predetermined range from the position of the first information processing device, coupons satisfying a predetermined condition are displayed on the screen as the usable coupons.

### (Note 2-9)

The program described in note 2-8, wherein the coupon satisfying the predetermined condition is a coupon having a highest discount amount or a highest discount rate.

### (Note 2-10)

The program described in note 2-8, wherein the coupon satisfying the predetermined condition is a coupon, an expiration period of which is within a predetermined period.

### (Note 2-11)

The program described in any one of notes 2-6 to 2-10, further causing the first information processing device to execute a detecting step for detecting a short-range wireless identifier, wherein

in the transmitting step, the received short-range wireless identifier is transmitted to the second information processing device.

### (Note 2-12)

An information processing method performed by a first information processing device used by a user, the information processing method comprising:

a first displaying step for displaying a first two-dimensional code for performing payment without applying a coupon;

a transmitting step for transmitting position information of the first information processing device to a second information processing device;

a receiving step for receiving, from the second information processing device, information indicating, among one or more coupons associated with the user, coupons usable within a predetermined range from a position of the first information processing device;

a second displaying step for displaying the received usable coupons on a screen; and

a third displaying step for displaying a second two-dimensional code for performing payment by applying the usable coupons, the second two-dimensional code being different from the first two-dimensional code.

### (Note 2-13)

An information processing device operating as a first information processing device used by a user, the information processing device comprising:

a display unit configured to display a first two-dimensional code for performing payment without applying a coupon;

a transmitting unit configured to transmit position information of the first information processing device to a second information processing device; and

a receiving unit configured to receive, from the second information processing device, information indicating, among one or more coupons associated with the user, coupons usable within a predetermined range from a position of the first information processing device, wherein

the displaying unit displays the received usable coupons on a screen and displays a second two-dimensional code for performing payment by applying the usable coupons, the second two-dimensional code being different from the first two-dimensional code.

### (Note 3-1)

An information processing method executed by a second information processing device that communicates with a first information processing device used by a first user, the information processing method comprising:

an extracting step for extracting, among one or more coupons associated with the first user, a coupon, an expiration period of which is set within a predetermined period, and one or more second users for whom a predetermined relation with the first user is set;

a first transmitting step for transmitting information indicating the coupon, the expiration period of which is set within the predetermined period, to the first information processing device;

a second transmitting step for transmitting information indicating the extracted one or more second users, for whom the predetermined relation with the first user is set, to the first information processing device;

a receiving step for receiving, from the first information processing device, information indicating the second user at an assignee indicating an assignee of the coupon, the expiration period of which is set within the predetermined period; and

a managing step for changing a user associated with the coupon, the expiration period of which is set within the predetermined period, from the first user to the second user as the assignee.

### (Note 3-2)

The information processing method described in note 3-1, wherein, in the managing step, when changing the user associated with the coupon, the expiration period of which is set within the predetermined period, from the first user to the second user as the assignee, a privilege of the coupon is reduced or increased.

### (Note 3-3)

The information processing method described in note 3-1 or 3-2, wherein, in the managing step, when changing the user associated with the coupon, the expiration period of which is set within the predetermined period, from the first user to the second user as the assignee, the expiration period of the coupon is extended.

### (Note 3-4)

The information processing method described in any one of notes 3-1 to 3-3, wherein, in the managing step, when changing the user associated with the coupon, the expiration period of which is set within the predetermined period, from the first user to the second user as the assignee, a history of change of the user associated with the coupon is recorded.

### (Note 3-5)

The information processing method described in note 3-4, wherein, in the managing step, when changing the user associated with the coupon, the expiration period of which is set within the predetermined period, from the first user to the second user as the assignee, the history of change is referred to and, when the second user is included in users associated with past of the coupon, the user associated with the coupon is not changed.

### (Note 3-6)

An information processing device operating as a second information processing device that communicates with a first information processing device used by a first user, the information processing device comprising:

an extracting unit configured to extract, among one or more coupons associated with the first user, a coupon, an expiration period of which is set within a predetermined period, and one or more second users for whom a predetermined relation with the first user is set;

a first transmitting unit configured to transmit information indicating the coupon, the expiration period of which is set within the predetermined period, to the first information processing device;

a second transmitting unit configured to transmit information indicating the extracted one or more second users, for whom the predetermined relation with the first user is set, to the first information processing device;

a receiving unit configured to receive, from the first information processing device, information indicating the second user at an assignee indicating an assignee of the coupon, the expiration period of which is set within the predetermined period; and

a managing unit configured to change a user associated with the coupon, the expiration period of which is set within the predetermined period, from the first user to the second user as the assignee.

### (Note 3-7)

A program for causing a second information processing device that communicates with a first information processing device used by a first user to execute:

an extracting step for extracting, among one or more coupons associated with the first user, a coupon, an expiration period of which is set within a predetermined period, and one or more second users for whom a predetermined relation with the first user is set;

a first transmitting step for transmitting information indicating the coupon, the expiration period of which is set within the predetermined period, to the first information processing device;

a second transmitting step for transmitting information indicating the extracted one or more second users, for whom the predetermined relation with the first user is set, to the first information processing device;

a receiving step for receiving, from the first information processing device, information indicating the second user at an assignee indicating an assignee of the coupon, the expiration period of which is set within the predetermined period; and

a managing step for changing a user associated with the coupon, the expiration period of which is set within the predetermined period, from the first user to the second user as the assignee.

### (Note 4-1)

An information processing method executed by a second information processing device that communicates with a first information processing device used by a user, the information processing method comprising:

a managing step for receiving, from the first information processing device, position information indicating a position of the first information processing device to manage the position of the first information processing device;

an extracting step for extracting coupons, an expiration period of which is set within a predetermined period, among one or more coupons owned by the user, the coupons being usable within a predetermined range from the position of the first information processing device; and

a transmitting step for transmitting the extracted usable coupons to the first information processing device.

### (Note 4-2)

The information processing method described in note 4-1, wherein, in the extracting step, when the coupon is extracted, a coupon satisfying a predetermined condition is extracted.

### (Note 4-3)

The information processing method described in note 4-2, wherein the predetermined condition includes a condition that a predetermined rank is highest.

### (Note 4-4)

The information processing method described in note 4-2 or 4-3, wherein the predetermined condition includes a condition that the coupon is usable within a range designated by the user.

### (Note 4-5)

The information processing method described in any one of notes 4-2 to 4-4, wherein the predetermined condition includes a condition that a number of coupons received by the user is smaller than a number decided by a maximum number of received coupons for each day designated by the user.

### (Note 4-6)

The information processing method described in any one of notes 4-2 to 4-5, wherein the predetermined condition includes a condition that the coupon is usable in a store where the user used the coupon in the past or a store having a predetermined relation with the store.

### (Note 4-7)

An information processing device operating as a second information processing device that communicates with a first information processing device used by a user, the information processing device comprising:

a managing unit configured to receive, from the first information processing device, position information indicating a position of the first information processing device to manage the position of the first information processing device;

an extracting unit configured to extract coupons, an expiration period of which is set within a predetermined period, among one or more coupons owned by the user, the coupons being usable within a predetermined range from the position of the first information processing device; and

a transmitting unit configured to transmit the extracted usable coupons to the first information processing device.

### (Note 4-8)

A program for causing a second information processing device, the second information processing device communicating with a first information processing device used by a user, to execute:

a managing step for receiving, from the first information processing device, position information indicating a position of the first information processing device to manage the position of the first information processing device;

an extracting step for extracting coupons, an expiration period of which is set within a predetermined period, among one or more coupons owned by the user, the coupons being usable within a predetermined range from the position of the first information processing device; and

a transmitting step for transmitting the extracted usable coupons to the first information processing device.

What is claimed is:

1. A computing device implemented method of settlement processing executed by one or more processors of a second computing device that communicates with a first computing device used by a first user, comprising:
electronically specifying one or more coupons associated with the first user;
electronically specifying one or more second users who has a predetermined relationship with the first user;
electronically transmitting information indicating the coupon to the first computing device;
electronically transmitting information indicating the specified one or more second users who has the predetermined relationship with the first user, to the first computing device;
electronically receiving information indicating at least one of the second user as an assignee of the coupon from the first computing device; and
electronically adding the second user as an assignee of the coupon to users associated with the coupon.

2. The method of claim 1,
wherein the coupon is a coupon that has predetermined expiration period.

3. The method of claim 1, further comprising:
deleting the first user from users associated with the coupon before adding the second user as an assignee of the coupon to users associated with the coupon.

4. The method of claim 1, further comprising:
in response to adding the second user as an assignee of the coupon to users associated with the coupon, reducing or increasing a privilege of the coupon.

5. The method of claim 1, further comprising:
in response to adding the second user as an assignee of the coupon to users associated with the coupon, electronically extending an expiration period of the coupon.

6. The method of claim 1, further comprising:
in response to adding the second user as an assignee of the coupon to users associated with the coupon, electronically recording a history of the users associated with the coupon.

7. The method of claim 6,
wherein, in the case adding the second user as an assignee of the coupon to users associated with the coupon, electronically referring to the history and not adding the second user to the users associated with the coupon when the second user is included in the history.

8. A computing device operating as a second computing device that communicates with a first computing device used by a first user, the computing device comprising:
a memory;
a processor communicatively coupled to the memory, where the processor is configured to perform:
specifying one or more coupons associated with the first user and one or more second users has a predetermined relationship with the first user is set;
transmitting information indicating the coupon to the first information processing device;
transmitting information indicating the specified one or more second users who has the predetermined relationship with the first user, to the first information processing device;
receiving, from the first information processing device, information indicating the second user at an assignee indicating an assignee of the coupon; and
adding the second user as an assignee associated with the coupon.

9. A computer-readable non-transitory storage medium storing a program for a second computing device, the second computing device that communicates with a first computing device used by a first user, the program comprising instruction for:
specifying one or more coupons associated with the first user;
specifying one or more second users who has a predetermined relationship with the first user;
transmitting information indicating the coupon to the first computing device;
transmitting information indicating the specified one or more second users who has the predetermined relationship with the first user, to the first computing device;
receiving information indicating at least one of the second user as an assignee of the coupon from the first computing device; and
adding the second user as an assignee to users associated with the coupon.
